(19) United States
(12) Patent Application Publication
(10) Pub. No.: US 2010/0131372 A1
(43) Pub. Date: May 27, 2010

(54) DATA PROCESSING DEVICE, COMPUTER PROGRAM, AND DATA STORAGE MEDIUM

(76) Inventors: Norikazu Takashima, Tokyo (JP); Miwa Kaneko, Tokyo (JP); Hiroshi Watanabe, Tokyo (JP)

Correspondence Address: BIRCH STEWART KOLASCH & BIRCH, PO BOX 747, FALLS CHURCH, VA, 22040-0747, US

(21) Appl. No.: 12/530,127

(22) PCT Filed: Mar. 4, 2008
(86) PCT No.: PCT/JP2008/000431

§ 371 Date: Sep. 4, 2009

(30) Foreign Application Priority Data
Mar. 5, 2007 (JP) 2007-053725

(51) Int. Cl. G06F 17/50; G06Q 10/00; G06Q 30/00; G09G 5/00

(52) U.S. Cl. 705/14.72; 703/1; 345/660

(57) ABSTRACT

A layout of unit images UP output for display may be modified by a layout operation through an input device 802. In addition, upon modification of the layout of the unit images UP, an actual work load is calculated corresponding to the modification of layout, and then output to be displayed. Accordingly, for an exemplary case of structural modification of a unit system used at a shop, a new layout of the frame units therefore may readily and preliminarily be examined, and also work load of the modification of layout may preliminarily and readily be confirmed. A data processing device, configured to assist efficient structural modification of the unit system formed based on an arbitrary combination of a plurality of types of unit components, is provided.

### TECHNICAL FIELD

The present invention relates to a data processing device used for assisting structural modification of a unit system formed based on an arbitrary combination of a plurality of types of unit components vertically engaged and laterally arranged; a data processing device providing a web site used for assisting structural modification of a commodity display system to a user terminal device via the Internet; a computer program utilized at the data processing devices; and a data storage medium storing the computer program.

### BACKGROUND ART

At present, cigarette packs are displayed as a commodity and sold at shops such as so-called convenience stores. The “cigarette pack” mentioned herein refers to a commodity having a plurality of individual cigarettes to be smoked enclosed in a rectangular solid package.

Therefore, the commodity display system for displaying cigarette packs is typically composed of a plurality of magazine units and one system frame. Each magazine unit is typically made of a colorless clear resin, and formed into an open-top box shape oblong in the depth-wise direction. Each magazine unit, keeping the cigarette packs upright therein, is accommodated from the top while arranging them in the depth-wise direction.

The system frame holds the plurality of magazine units while arranging them in the vertical and lateral directions. In this way, the conventional commodity display system can display the cigarette packs in a vertically and laterally arranged manner.

Construction of an attractive sales floor is an important factor in view of promoting sales of commodities such as cigarette packs. Among various factors necessarily taken into consideration for constructing the sales floor, the size of the location where commodities are to be displayed is key.

Conventionally, sales floors for commodities have mainly resided on broad floors such as those in shopping malls, large volume sales stores and so forth. Recent changes in marketing style, however, have allowed for a large growth of narrow-and-small sales floors such as those in convenience stores.

In this sort of narrow-and-small sales floor, the most important theme of marketing strategies is how to bring about maximum appeal to the customers with limited space. However, conventionally, there has not been sufficient evaluation of the construction of sales floors which are highly appealing to the customers in this sort of narrow-and-small sales floor. Moreover, most commodity display systems introduced into shops are fixed, allowing only limited strategies for constructing sales floors.

In particular, for narrow-and-small shops such as convenience stores, the commodity display systems have rarely been developed from the viewpoint of customer appeal and contributing to the sales floor organization. This is because it has been necessary to ensure sales spaces for installing the commodity display systems so as to complete installation of the system within a short time.

[Patent Document 1] Japanese Laid-Open Patent Publication No. 2004-151955

### DISCLOSURE OF THE INVENTION

In order to solve the above-described subjects, the present applicant previously invented a unit-structured commodity display system filed as Japanese Patent Application No. 2006-266625. In this commodity display system, a plurality of types of unit components are arbitrarily combined, vertically engaged, and laterally arranged.

Therefore, the commodity display system can readily be transported and rapidly installed, even at narrow-and-small shops. In addition, highly appealing sales floors can be produced, by virtue of its large flexibility in terms of location of installation and cigarette pack display style.

In particular, the above-described commodity display system may be modified in the structure, by re-assembling the unit components, even after being introduced into the shop. Therefore, the system may flexibly be adaptable to renewal of the shop or sales floor.

The number of combinations of the unit components is, however, huge due to an extremely large degree of freedom of the commodity display system. For this reason, a worker at the shop, who is going to re-assembling the unit components of the commodity display system, may feel a great difficulty in determining a new combination.

The above-described commodity display system is freely modifiable also in dimensions in the lateral and vertical directions, by re-assembling work of the unit components. Therefore, for an exemplary case of renewal of the sales floor, it may sometimes be necessary for the commodity display system to be structurally modified, while taking the occupied dimension thereof into consideration. The worker may, therefore, feel a still larger difficulty in determining an optimum combination of the unit components.

Moreover, for an exemplary case where the unit system such as the commodity display system is structurally modified as described in the above, the task therefore is not a sort of routine task. In the shops or the like at present, the number of workers and the work time are carefully adjusted taking the work load into consideration, for each of various tasks.

However, due to non-routine nature of the structural modification of the commodity display system, it may be difficult to preliminarily confirm the work load. For this reason, the task once actually started would accidentally remain unfinished by the scheduled time.

In particular, some of the shops such as convenience stores stay open around the clock. In this sort of shops, the structural modification of the commodity display system may take place in a time zone with a minimum number of customers.

On the other hand, the shops such as convenience stores have extremely small numbers of workers, despite their extremely long business hours. For this reason, it may be impossible to thoughtlessly mobilize a large number of workers, even for the case where the structural modification of the commodity display system is finished within a predetermined duration of time.

As a consequence, for the structural modification of the commodity display system at the shops such as convenience stores, it may be critical to preliminarily confirm the number of workers and work time necessary to finish the task.

Conventionally, typically by the above-described Patent Document 1, proposals have been made regarding techniques of simulating how to display commodities such as cigarette packs on fittings such as a system frame, aiming at ideal organization of sales floors. However, the technique disclosed in Patent Document 1 allows simulation on how to display commodities only for fitting of fixed structures.

Therefore, the technique disclosed in Patent Document 1 could not simulate any combinations of the unit components of the commodity display system widely modifiable in the structure, and could not organize an ideal sales floor.

The present invention is conceived after considering the above-described subjects, and is to provide a data processing device configured to assist efficient structural modification of a unit system formed based on an arbitrary combination of a plurality of types of unit components.

According to the present invention, there is provided a first data processing device used for assisting structural modification of a unit system formed based on an arbitrary combination of a plurality of types of unit components vertically engaged and laterally arranged, including:

a display device that outputs various data to be displayed on a screen;

an input device that accepts various input operations;

a unit storage unit that stores unit data including unit images modeled after front geometry of each of the plurality of types of unit components on a predetermined scale of reduction;

a layout storage unit that stores layout data of the plurality of unit components composing the unit system;

an image display unit that outputs the plurality of unit images to be displayed on the screen, according to a layout corresponded to the stored layout data;

an operation detection unit that detects a layout operation which is effected through the input device on the unit images output for display;

a unit layout unit that modifies the layout of the unit images output for display on the screen, corresponding to the detected layout operation;

a result calculation unit that calculates work load of the structural modification of the unit system, corresponding to the modification of layout; and

a result output unit that outputs the calculated work load to be displayed on the screen.

According to the data processing device of the present invention, a plurality of unit images are arranged corresponding to preliminarily-entered layout data, and then output to be displayed. The layout of the unit images thus output to be displayed can be modified by a layout operation through an input device. When the layout of the unit images is modified, an actual work load correspondent to the modification of layout is calculated, and output to be displayed. Accordingly, for an exemplary case where the unit system, such as commodity sales systems used at the shops, is structurally modified, a new layout of the unit components can preliminarily and readily examined, and also the work load of the modification of layout can preliminarily and readily be confirmed.

According to the present invention, there is provided a second data processing device which provides, via the Internet, a user terminal device with a web site used for assisting structural modification of a unit system including a plurality of unit components vertically engaged and laterally arranged, including:

a unit storage unit that stores unit data including unit images modeled after front geometries of each of the plurality of types of unit components on a predetermined scale of reduction;

a layout storage unit that stores, on the worker basis, a layout data of each of the plurality of unit components composing the unit system;

a login acceptance unit that accepts login by the worker through the user terminal device on which the web site is browsed;

an image display unit that outputs the plurality of unit images to be displayed on the screen of the web site, according to a layout corresponded to the layout data of the logged-in worker;

an operation detection unit that detects a layout operation effected through the input device on the unit images output for display;

a unit layout unit that modifies the layout of the unit images output for display on the screen, corresponding to the detected layout operation;

a result calculation unit that calculates work load of the structural modification of the unit system, corresponding to the modification of layout; and

a result output unit that outputs the calculated work load to be displayed on the screen.

According to the data processing device of the present invention, a web site to be browsed on the user terminal device may be established on the Internet, and the user can login the web site through the user terminal device. A plurality of unit images are then output to be displayed on the web site in an arranged form, corresponding to the layout data preliminarily entered by the user. The user can modify, through the user terminal device, the layout of the unit images thus output to be displayed. If the layout of the unit images is thus modified, an actual work load correspondent to the modification of layout is output to be displayed. As a consequence, for an exemplary case of structural modification of the unit system, such as a commodity sales system being used in the shop, a new layout of the unit components can preliminarily and readily be examined, and also the work load of the modification of layout can preliminarily and readily be confirmed.

According to the present invention, there is provided a first computer program for a data processing device including a display device that outputs various data to be displayed on a screen, and an input device that accepts various input operations, and is used for assisting structural modification of a unit system formed based on an arbitrary combination of a plurality of types of unit components vertically engaged and laterally arranged, the computer program allowing the data processing device to execute:

unit storage processing of storing unit data including unit images modeled after front geometry of each of the plurality of types of unit components on a predetermined scale of reduction;

layout storage processing of storing a layout data of the plurality of unit components composing the unit system;

image display processing of outputting the plurality of unit images to be displayed on the screen, according to a layout corresponded to the stored layout data;

operation detection processing of detecting a layout operation effected through the input device on the unit images output for display;

unit layout processing of modifying the layout of the unit images output for display on the screen, corresponding to the detected layout operation;

result calculation processing of calculating work load of the structural modification of the unit system, corresponding to the modification of the layout; and

result output processing of outputting the calculated work load to be displayed on the screen.

According to the present invention, there is provided a second computer program for a data processing device which provides, through the Internet, a user terminal device with a web site used for assisting structural modification of a unit system including a plurality of unit components vertically engaged and laterally arranged, the computer program allowing the data processing device to execute:

unit storage processing of storing unit data including unit images modeled after front geometries of each of the plurality of types of unit components on a predetermined scale of reduction;

layout storage processing of storing, on the worker basis, a layout data of each of the plurality of unit components composing the unit system;

login acceptance processing of accepting login by the worker through the user terminal device on which the web site is browsed;

image display processing of outputting the plurality of unit images to be displayed on the screen of the web site, according to a layout corresponded to the layout data of the logged-in worker;

operation detection processing of detecting a layout operation effected through the input device on the unit images output for display;

unit layout processing of modifying the layout of the unit images output for display on the screen, corresponding to the detected layout operation;

result calculation processing of calculating workload of the structural modification of the unit system, corresponding to the modification of layout; and

result output processing of outputting the calculated work load to be displayed on the screen.

According to the present invention, there is provided a first data storage medium for a data processing device including a display device that outputs various data to be displayed on a screen, and an input device that accepts various input operations, and is used for assisting structural modification of a unit system formed based on an arbitrary combination of a plurality of types of unit components vertically engaged and laterally arranged, the data storage medium storing a computer program that allows the data processing device to execute:

unit storage processing of storing unit data including unit images modeled after front geometries of each of the plurality of types of unit components on a predetermined scale of reduction;

layout storage processing of storing a layout data of the plurality of unit components composing the unit system;

image display processing of outputting the plurality of unit images to be displayed on the screen, according to a layout corresponded to the stored layout data;

operation detection processing of detecting a layout operation effected through the input device on the unit images output for display;

unit layout processing of modifying the layout of the unit images output for display on the screen, corresponding to the detected layout operation;

result calculation processing of calculating work load of the structural modification of the unit system, corresponding to the modification of the layout; and

result output processing of outputting the calculated work load to be displayed on the screen.

According to the present invention, there is provided a second data storage medium for a data processing device which provides, through the Internet, a user terminal device with a web site used for assisting structural modification of a unit system that includes a plurality of unit components vertically engaged and laterally arranged, the data storage medium storing a computer program that allows the data processing device to execute:

unit storage processing of storing unit data including unit images modeled after front geometries of each of the plurality of types of unit components on a predetermined scale of reduction;

layout storage processing of storing, on the worker basis, a layout data of each of the plurality of unit components composing the unit system;

login acceptance processing of accepting login by the worker through the user terminal device on which the web site is browsed;

image display processing of outputting the plurality of unit images to be displayed on the screen of the web site, according to a layout corresponded to the layout data of the logged-in worker;

operation detection processing of detecting a layout operation effected through the input device on the unit images output for display;

unit layout processing of modifying the layout of the unit images output for display on the screen, corresponding to the detected layout operation;

result calculation processing of calculating workload of the structural modification of the unit system, corresponding to the modification of layout; and

result output processing of outputting the calculated work load to be displayed on the screen.

Note that the depth-wise direction and the lateral direction, defined in the present invention in addition to the vertical direction, are merely for the convenience's sake in order to simplify explanation of relative relations of the constituents of the present invention, and by no means limit the directions relevant to manufacturing and use in embodiments of the present invention.

In addition, the individual constituents of the present invention are not necessarily independent entities, instead allowing that a plurality of constituents is formed to give a single component, that a single constituent is formed by a plurality of components, and that a certain constituent is a part of other constituent, for example.

“Storing data” in the context of the present invention means that the device of the present invention has at least a function of storing data. The present invention therefore allows not only that the device of the present invention stores data newly registered by the consumer; but also that the device stores data registered by the supplier at manufacturing and does not accept any registration of new data by the consumer after the shipment.

According to the data processing device of the present invention, the layout of the unit images output for display can be modified by a layout operation through the input device. If the layout of the unit images is thus modified, an actual work load correspondent to the modification of layout is output to be displayed. For an exemplary case of structural modification of the unit system, such as a commodity sales system being used in the shop, a new layout of the unit components can preliminarily and readily be examined, and also the work load of the modification of layout can preliminarily and readily be confirmed. As a consequence, even when the unit system needs be re-assembled for the purpose of renewal of the sales floor at the shop, how many workers and how long time are necessary to finish the task can preliminarily be confirmed, and thereby an efficient structural modification of the unit system can be assisted.

### BRIEF DESCRIPTION OF THE DRAWINGS

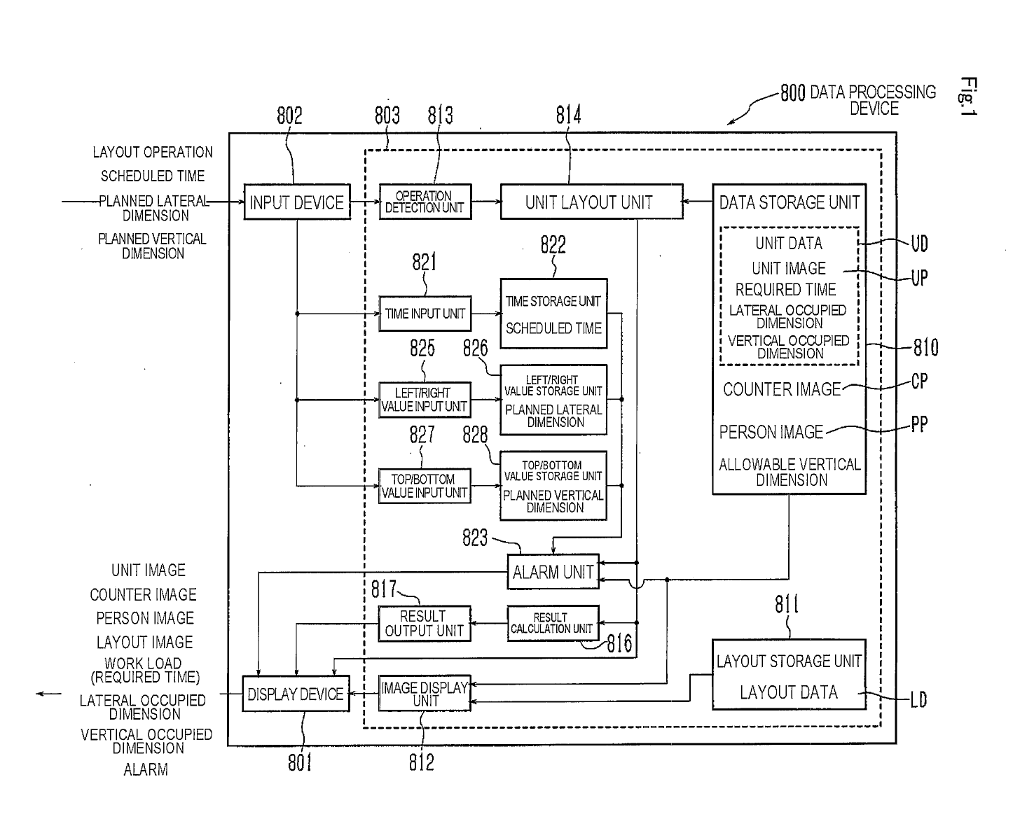

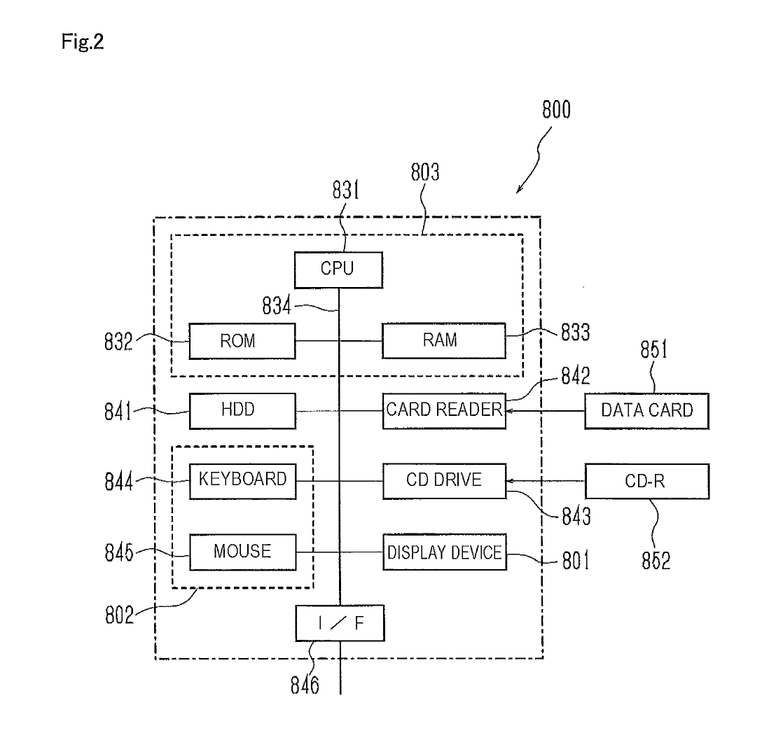

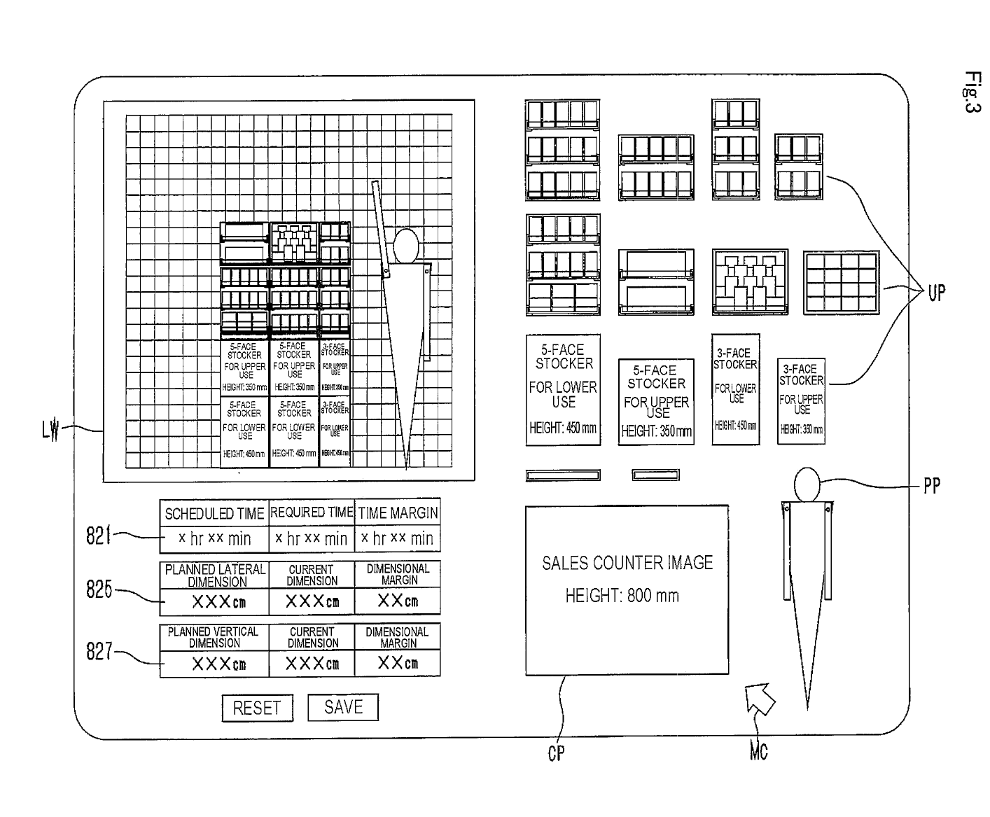

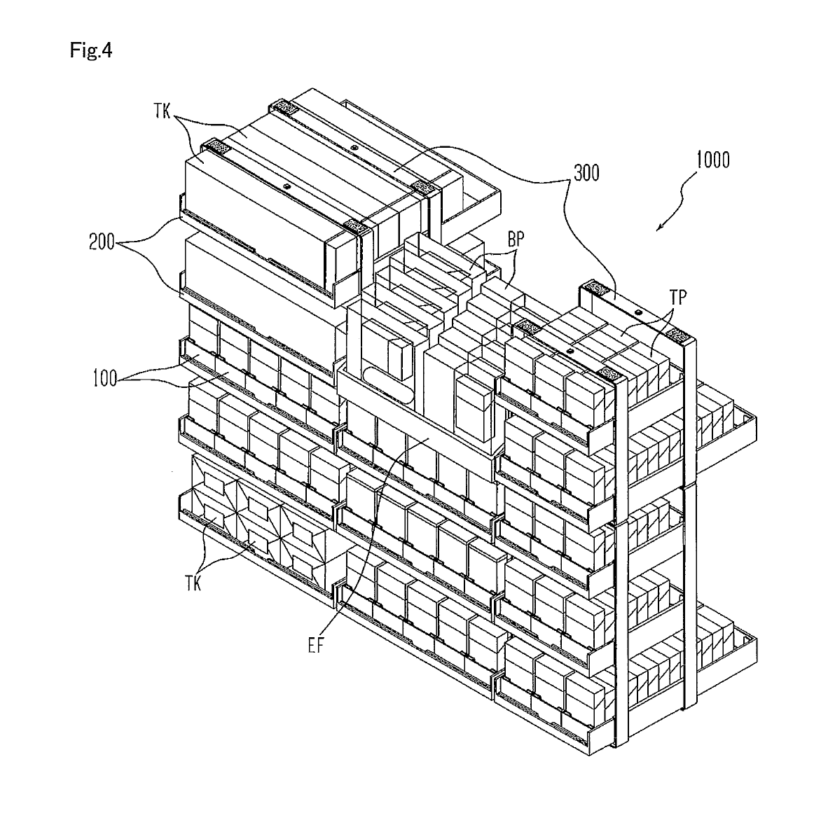

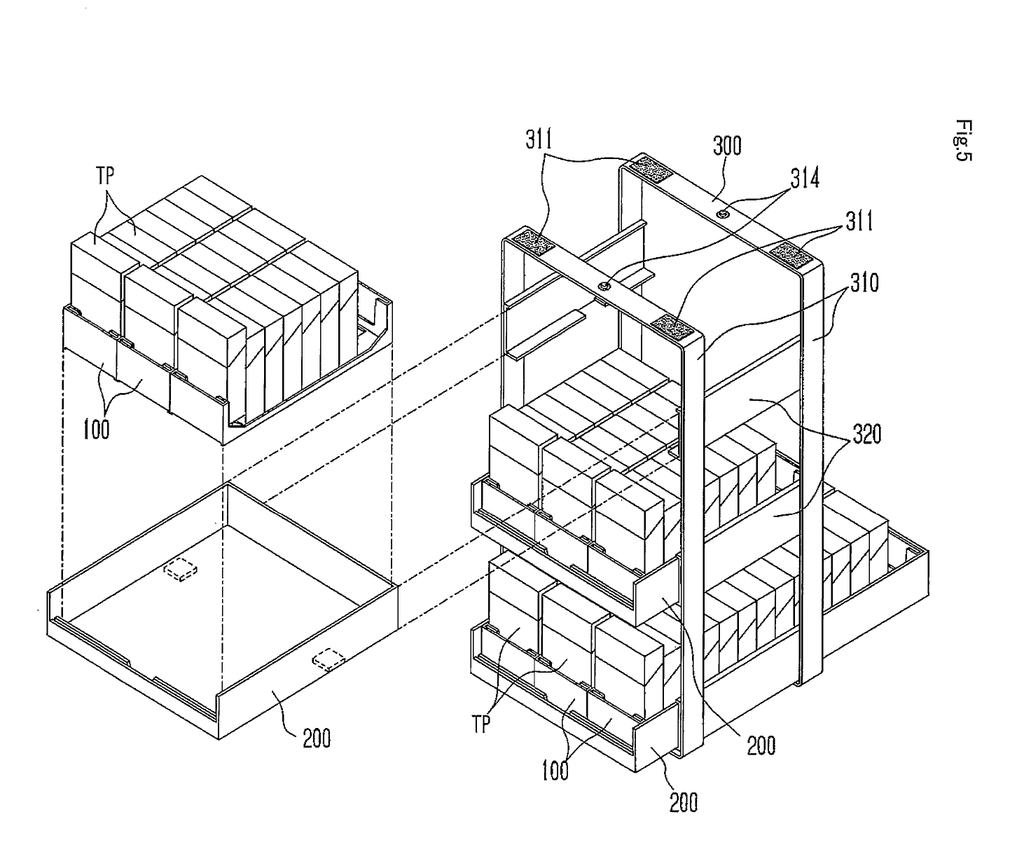

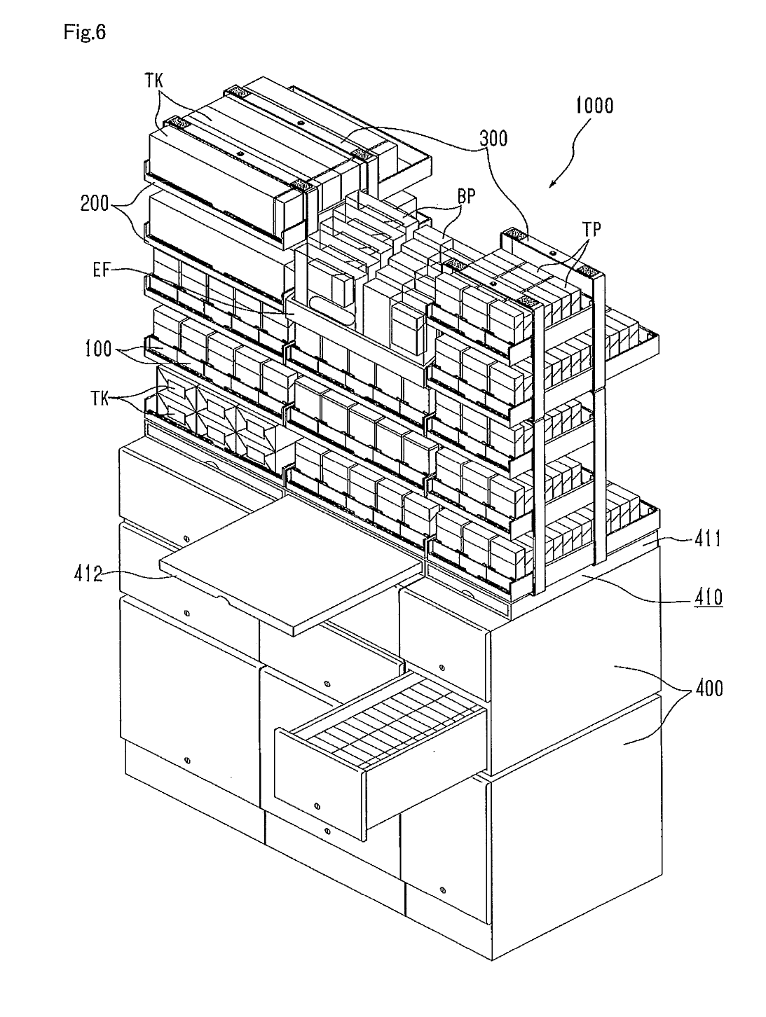

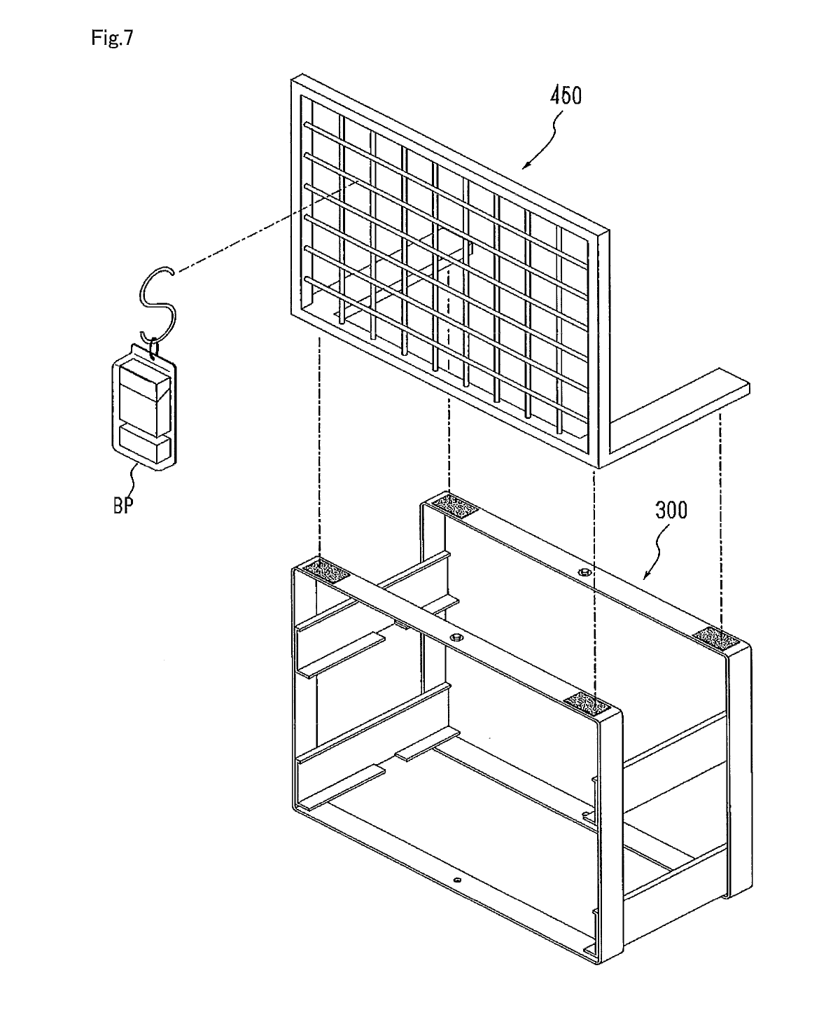

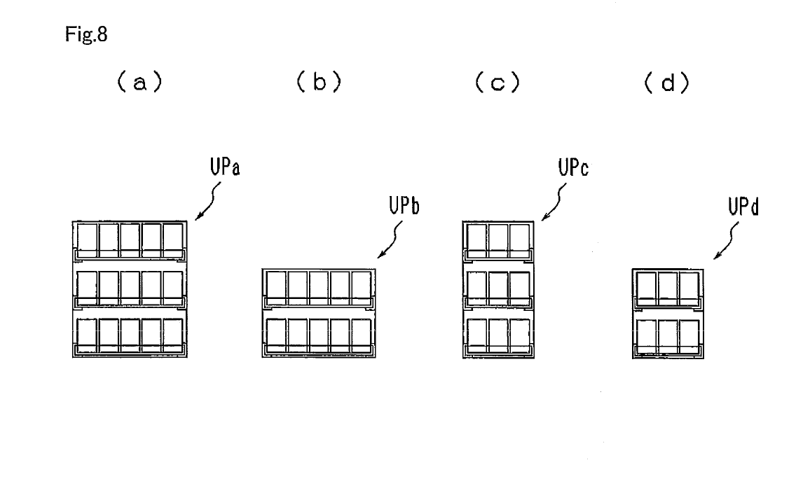

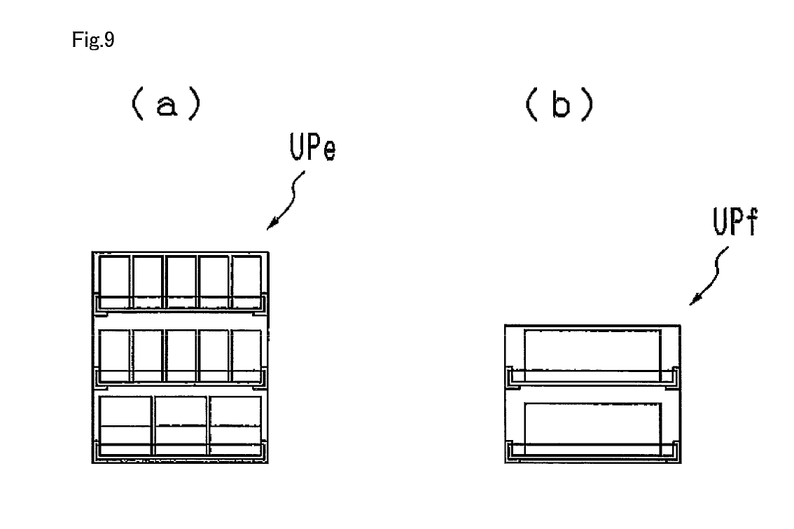

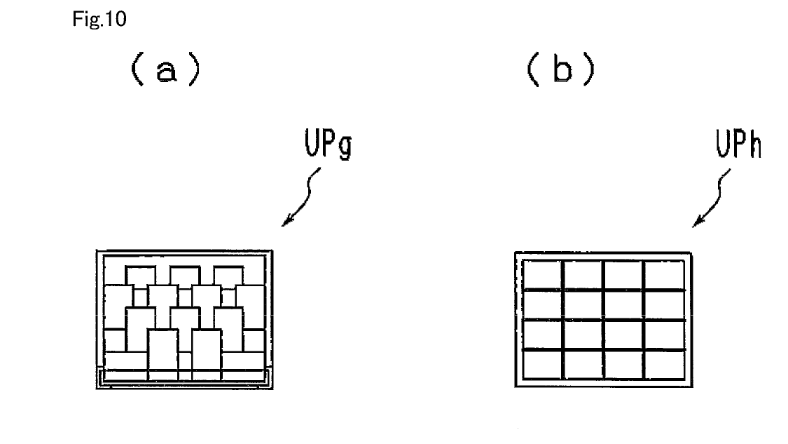

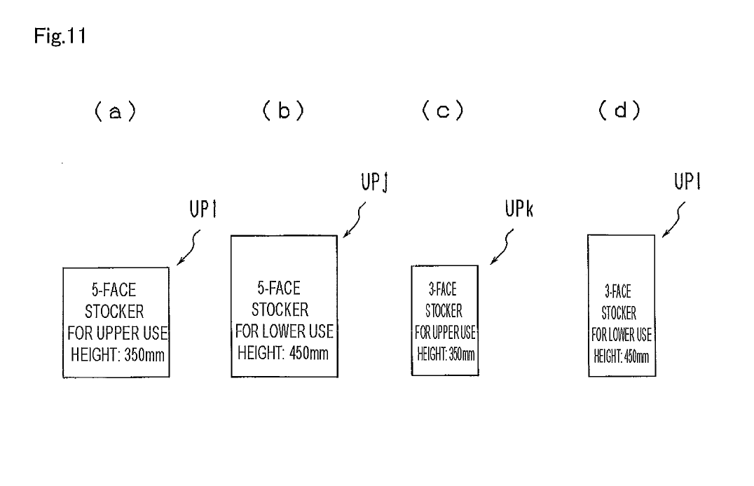

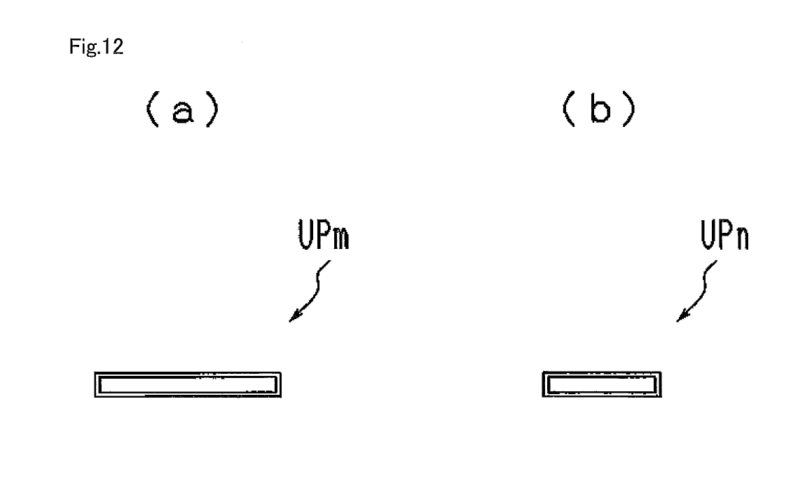

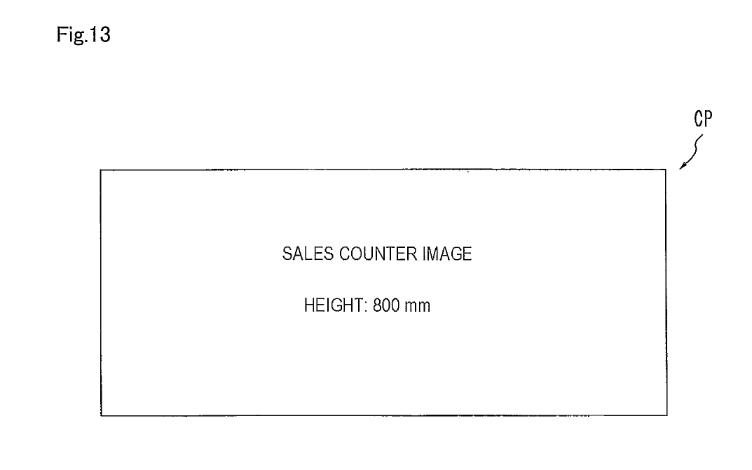

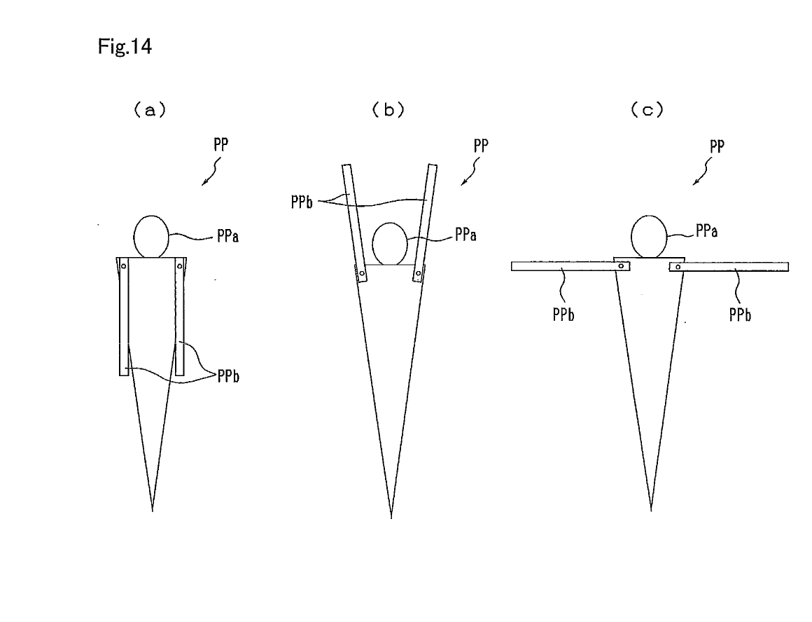

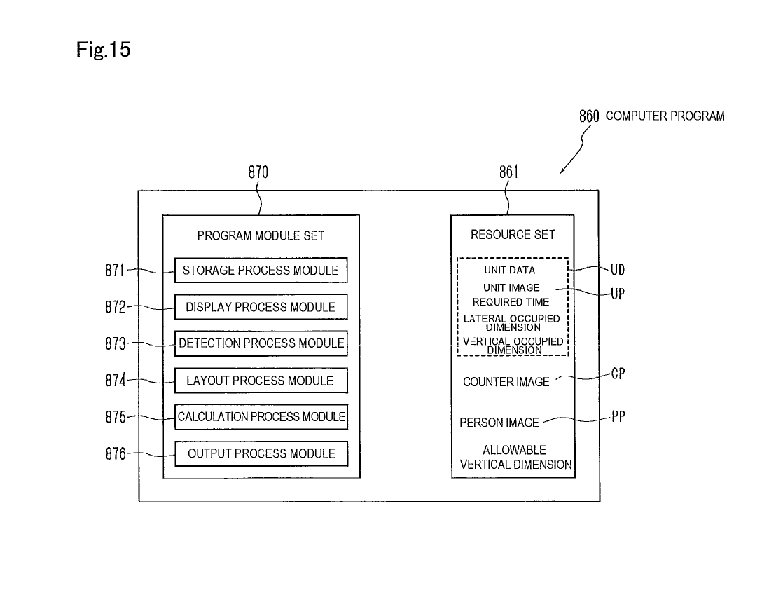

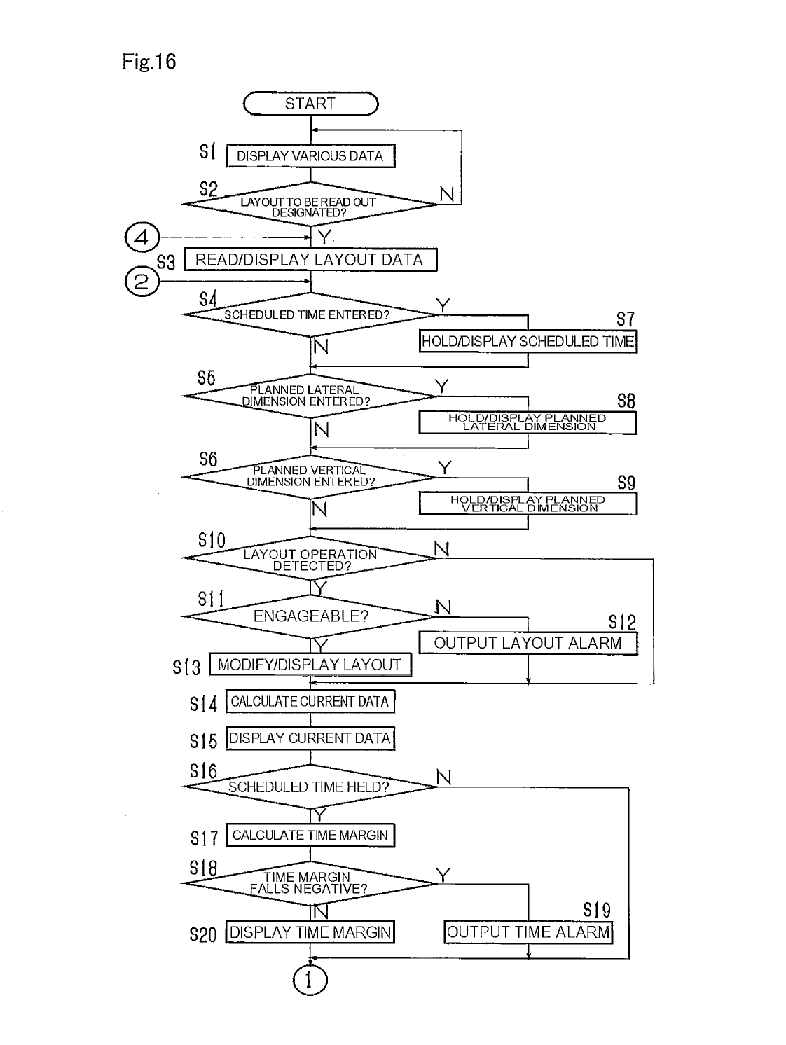

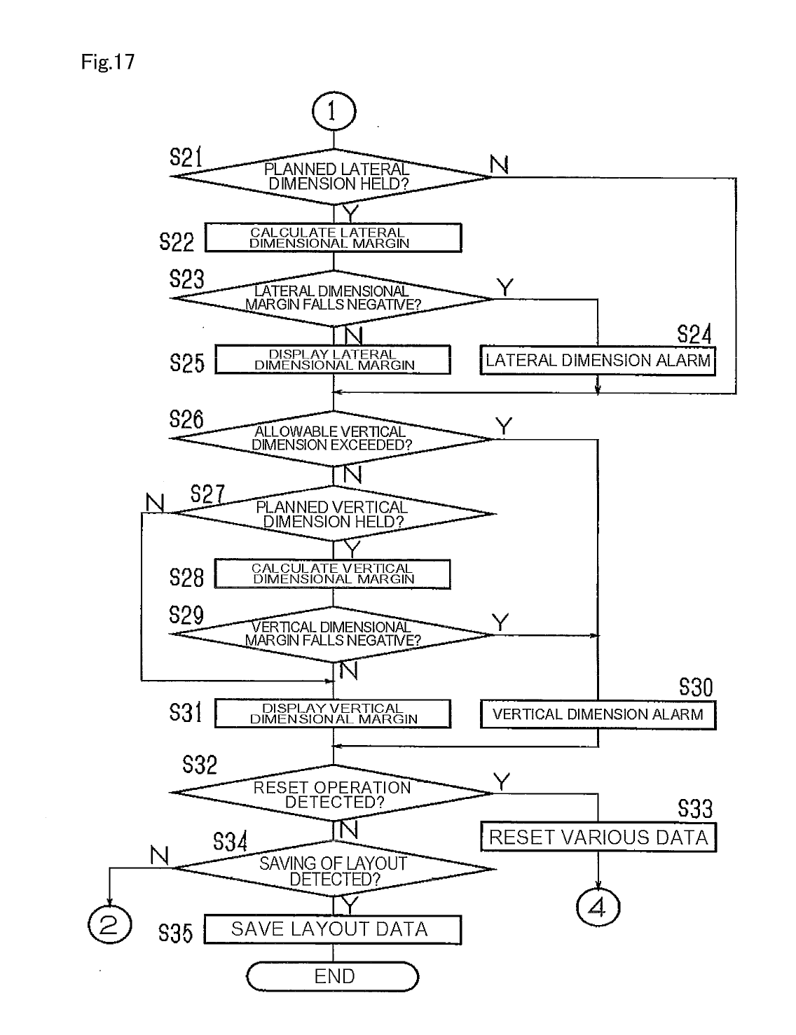

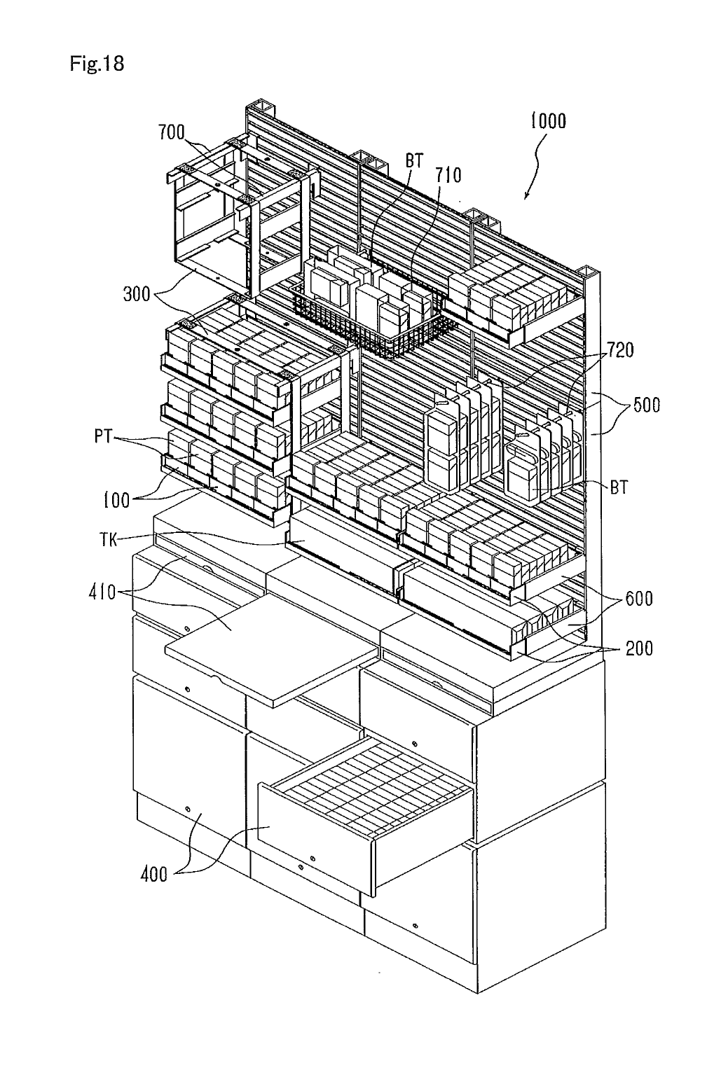

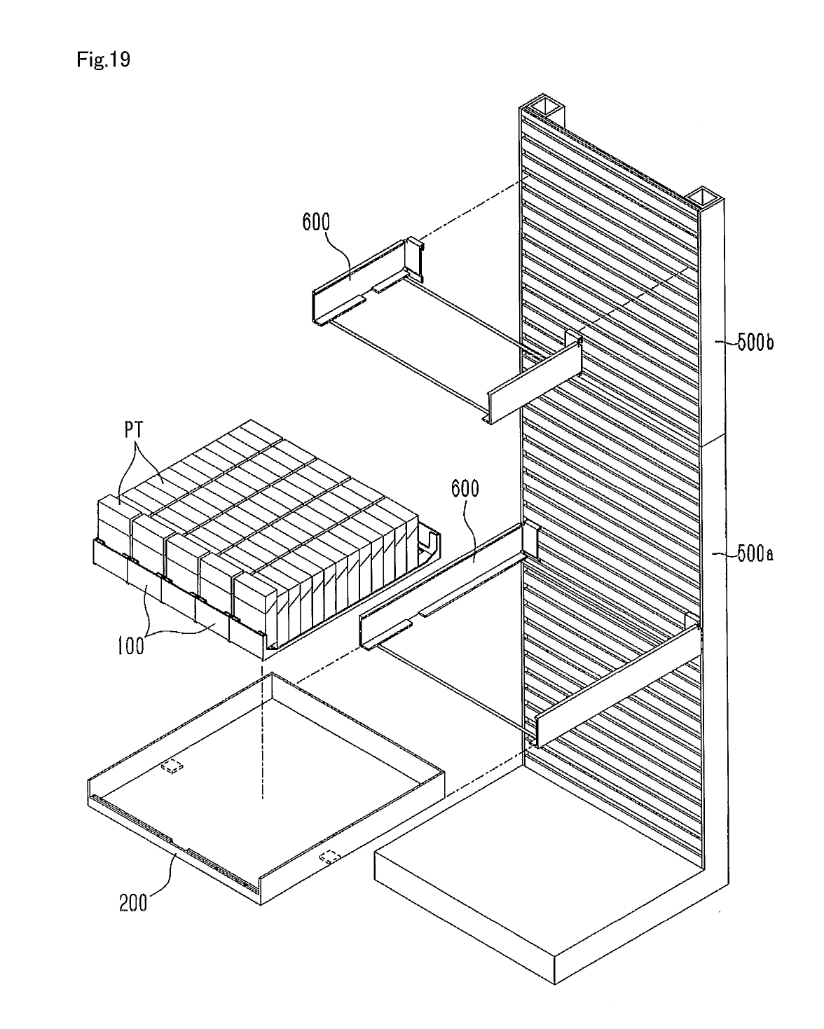

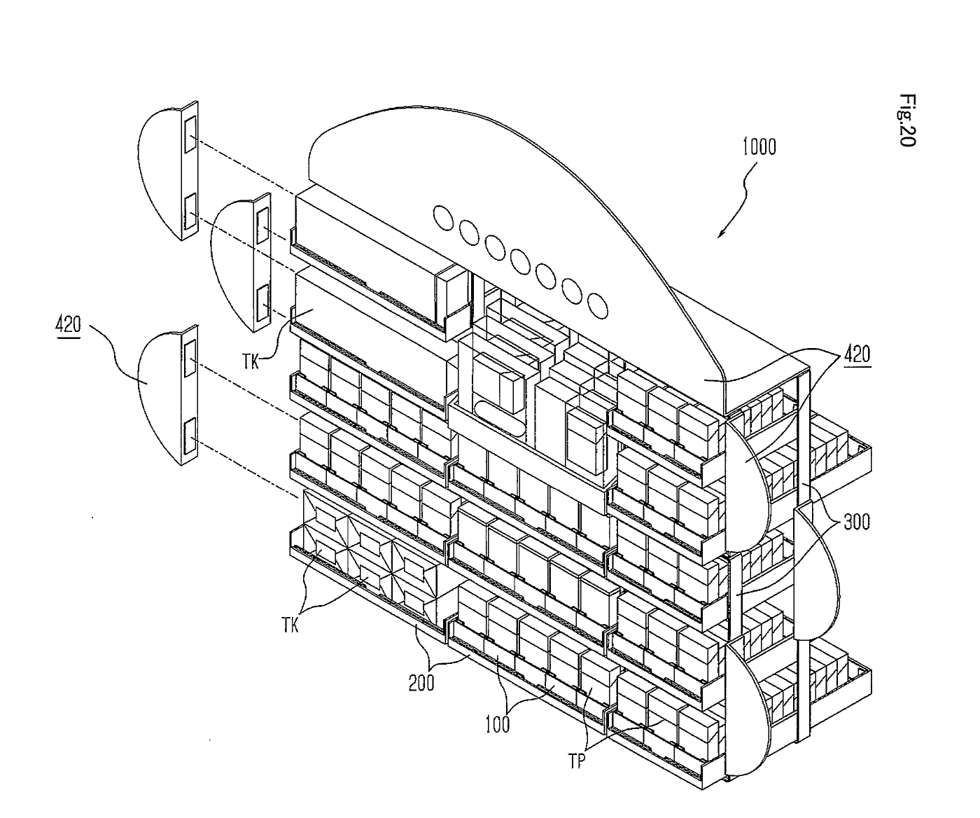

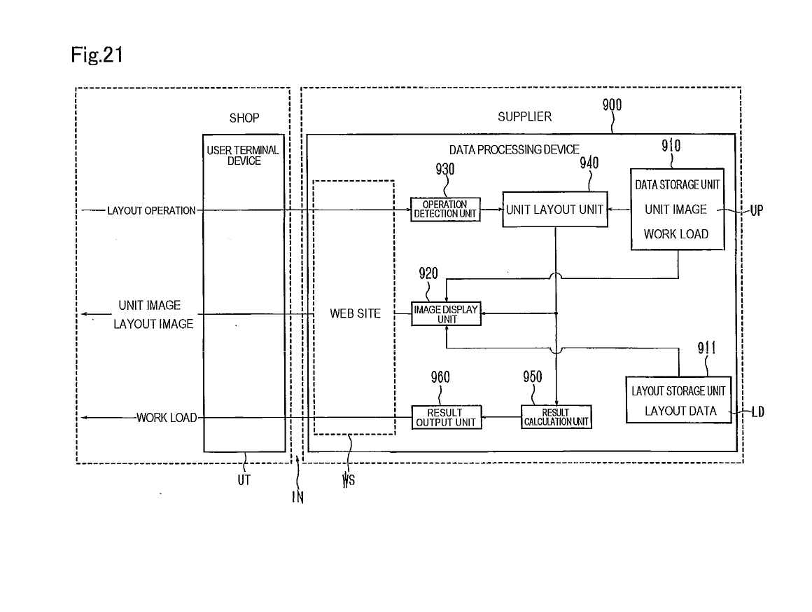

The above and other objects, features and advantages of the present invention will be more apparent from the following description of certain preferred embodiments taken in conjunction with the accompanying drawings.

[FIG. 1] A schematic drawing illustrating a logical structure of a data processing device according to an embodiment of the present invention.

[FIG. 2] A block diagram illustrating a physical structure of the data processing device.

[FIG. 3] A schematic drawing illustrating a displayed image on a screen of a display device of the data processing device.

[FIG. 4] A perspective view illustrating an appearance of a cigarette display system as the unit system.

[FIG. 5] An exploded perspective view illustrating a structure of a main portion of the cigarette display system.

[FIG. 6] A perspective view illustrating an appearance of the cigarette display system adopting stocker units.

[FIG. 7] An exploded perspective view illustrating a mesh unit of the cigarette display system.

[FIG. 8] Schematic drawings illustrating four types of unit image.

[FIG. 9] Schematic drawings illustrating two further types of unit image.

[FIG. 10] Schematic drawings illustrating two still further types of unit image.

[FIG. 11] Schematic drawings illustrating four further types of unit image.

[FIG. 12] Schematic drawings illustrating two still further types of unit image.

[FIG. 13] A schematic drawing illustrating a sales counter image.

[FIG. 14] A schematic drawing illustrating a person image.

[FIG. 15] A schematic drawing illustrating a logical structure of a computer program.

[FIG. 16] A flow chart illustrating the former half of a processing operation of the data processing device.

[FIG. 17] A flow chart illustrating the latter half.

[FIG. 18] A perspective view illustrating an appearance of another cigarette display system.

[FIG. 19] An exploded perspective view illustrating a structure of a main portion of the cigarette display system.

[FIG. 20] An exploded perspective view illustrating still another cigarette display system.

[FIG. 21] A schematic drawing illustrating a logical structure of still another data processing device.

### BEST MODES FOR CARRYING OUT THE INVENTION

One embodiment of the present invention will be explained referring to the attached drawings. A data processing device 800 of this embodiment, detailed later, is used for assisting structural modification of a cigarette display system 1000 which is a unit system formed based on an arbitrary combination of a plurality of types of frame units 300 as the unit components vertically engaged and laterally arranged.

As illustrated in FIG. 1, the data processing device 800 has, as the hardware, a display device 801 outputting various data to be displayed on a screen; an input device 802 accepting various input operations; a computer unit 803 executing various types of data processing, and so forth.

For more details, as illustrated in FIG. 2, the computer unit 803 has a CPU (Central Processing Unit) 831 executing various types of data processing, a ROM (Read Only Memory) 832 storing various data in a fixed manner, a RAM (Random Access Memory) 833 temporarily storing various data, and so forth, all of which are connected through a bus line 834.

The bus line 834 is further connected to hardware including a HDD (Hard Disc Drive) 841 storing large volume of various data, a card reader 842 allowing thereon loading and unloading of a data card 851, a CD drive 843 allowing loading and unloading of a CD-R (Compact Disc-Recordable) 852 thereon, a keyboard 844 and a mouse 845 as an input device 802, a display device 801 typically composed of an LCD (Liquid Crystal Display), and an I/F (Interface) unit 846.

In the data processing device 800 of this embodiment, the ROM 832, the RAM 833, the HDD 841, the removable data card 851, the removable CD-R 852, and so forth correspond to the data storage medium, wherein at least one of which stores various computer programs 860 for the CPU 831, as detailed later.

The data processing device 800 executes various types of data processing, such as image display by the display device 801, corresponding to the computer program 860, data entered through the input device 802 and so forth.

The data processing device 800 for this purpose logically includes a display device 801 which outputs various data to be displayed on a screen; an input device 802 which accepts various input operations; a data storage unit 810 as a unit storage unit which stores unit data including unit images UP modeled after front geometry of each of the plurality of types of frame units 300 and so forth on a predetermined scale of reduction; a layout storage unit 811 which stores a layout data LD of the plurality of frame units 300 and so forth composing the cigarette display system 1000; an image display unit 812 which outputs the plurality of unit images UP to be displayed on the screen, according to a layout corresponded to the stored layout data LD; an operation detection unit 813 which detects a layout operation effected through the input device 802 on the unit images UP output for display; a unit layout unit 814 which modifies the layout of the unit images UP output for display on the screen, corresponding to the detected layout operation; a result calculation unit 816 which calculates work load of the structural modification of the cigarette display system 1000, corresponding to the modification of layout; and a result output unit 817 which outputs the calculated work load to be displayed on the screen.

More specifically, the cigarette display system 1000, for which a layout of the frame units 300 is simulated using the data processing device 800 of this embodiment, is configured as illustrated in FIG. 4 to have a plurality of magazine units 100 each of which are formed into a depth-wisely oblong, open-top box so as to hold a plurality of cigarette packs TP arranged therein in the depth-wise direction; a plurality of tray units 200 each of which being formed into an open-top box so as to hold the plurality of magazine units 100 arranged thereon in the lateral direction in a freely replaceable manner; a plurality of frame units 300 formed into an open-front box so as to hold the plurality of tray units 200 arranged therein in a freely detachable manner while keeping them distant from each other in the vertical direction; and a vertical engagement mechanism engaging the plurality of frame units 300 in the vertical direction.

The cigarette display system 1000 displays cigarette packs TP as commodities, cigarette cartons TK each of which being a commodity containing a plurality of cigarette packs TP packaged therein, box packs BP each of which being a commodity containing a cigarette pack TP packaged together with some novelty goods, and so forth. The box packs BP are typically supplied to the shops together with simple fittings EF made of cardboard.

At present, the cigarette packs TP are formed into rectangular solids having the depth-wise and lateral dimensions generally in common, while allowing some difference in the vertical dimension. In this embodiment, the largest surfaces of the cigarette pack TP are defined as the front surface and the rear surface, and the smallest surfaces are defined as the top surface and the bottom surface.

General cigarette pack TP has a brand name and so forth printed on the front surface (and rear surface). Therefore, the cigarette packs TP may preferably be displayed in an appropriate state while keeping the front surfaces thereof facing towards the front. Each magazine unit 100 accommodates a plurality of cigarette packs TP arranged in the depth-wise direction, while keeping each pack in the appropriate direction as described in the above, as illustrated in FIG. 5.

Also the tray unit 200 is formed into an open-top box using a colorless clear resin. In each tray unit 200, a plurality of magazine units 100 are accommodated while being arranged in the lateral direction.

Note that, in the cigarette display system 1000 of this embodiment, there are wide tray units 200 capable of accommodating five magazine units 100 and narrow tray units 200 capable of accommodating three magazine units 100, as illustrated in FIG. 4.

The frame unit 300 is composed of a pair of main frames 310 and a plurality of support frames 320, as illustrated in FIG. 5. Each main frame 310 is composed of a metal plate bent so as to give a rectangular frame geometry in the front view, and the pair of which are arranged in the depth-wise direction.

Each support frame 320 is made of a metal plate formed into a thin oblong rail extended in the depth-wise direction so as to support the tray unit 200, a plurality of which are arranged in the vertical direction and joined to the inner surfaces of the pair of main frames 310.

The tray units 200 herein are available in two types different in the lateral dimension, as described in the above. Therefore in the cigarette display system 1000 of this embodiment, there are the frame unit 300 holding three wide tray units 200, the frame unit 300 holding two wide tray units 200, the frame unit 300 holding three narrow tray units 200, and the frame unit 300 holding two narrow tray units 200, as illustrated in FIG. 4.

In the frame unit 300, the main frames 310 are attached with surface fasteners 311 which serve as the vertical engagement mechanism, on the top surfaces and bottom surfaces thereof on both end portions. The main frames 310 are provided with frame through-holes (not illustrated) which serve as recesses of the frame, at the individual centers of the bottom surfaces thereof. The main frames 310 are provided also with projection components 314 which serve as projections of the frame, at the individual centers of the top surfaces thereof.

Accordingly, in the cigarette display system 1000 of this embodiment, a plurality of frame units 300 having the same width, when vertically arranged, can be engaged with the aid of the surface fasteners 311, as illustrated in FIG. 4. At the same time, the frame through-holes and the projection components 314 are engaged.

The above-described cigarette display system 1000 is generally installed over the sales counter (not illustrated) of a shop. Meanwhile, the cigarette display system 1000 additionally has stocker units 400 and table units 410, as illustrated in FIG. 6, for the convenience of installation at locations having no sales counter.

Each stocker unit 400 is formed into a box shape having a flat surface at least on the top, and can freely be opened and closed from the front. Each table unit 410 is formed into a vertically-flattened box shape having a flat top surface.

Each table unit 410 is configured to have a unit box 411 and table components 412 housed therein in a freely slidable manner in the depth-wise direction. The table component 412 can therefore be drawn out to the front, for the convenience of operability.

Since the frame units 300 are available in two types of lateral dimension as described in the above, the stocker units 400 and the table units 410 are also available in two types of lateral dimension corresponding to the frame units 300. In this way, the stocker units 400 and the table units 410 can also be combined corresponding to the frame units 300 to be adopted.

Since the tray units 200 are also available in two types of depth-wise length, so that the stocker units 400 and the table units 410 are formed to have a depth-wise length corresponding to the tray unit 200 having the largest depth-wise length.

Accordingly, whichever types of tray units 200 are used, the tray units 200 will not project out from the stocker units 400. By using the above-described stocker units 400, the cigarette display system 1000 can appropriately be installed, even at places having no sales counter (not illustrated).

Therefore, in the data processing device 800 which simulates the cigarette display system 1000 configured as described in the above, the data storage unit 810 stores unit images UP modeled after the display style of cigarette packs TP on the basis of the individual types of the frame unit 300.

Now, at least a part of the plurality of types of frame units 300 is designated with a plurality of display styles. Accordingly, the data storage unit 810 stores a plurality of types of unit images UP modeled after a plurality of types of display styles.

For more details, basically in the cigarette display system 1000, the magazine units 100 are loaded on the tray units 200 loaded on the frame unit 300, and the cigarette packs TP are accommodated in the magazine units 100 as illustrated in FIG. 4 to FIG. 6.

Accordingly, the unit images UP modeled after the front geometries of the frame units 300 are set to the individual unit data UD while containing, as illustrated in FIG. 8, a unit image UPa representing a state of use having the tray units 200 vertically loaded in three layers, each tray unit 200 having the cigarette packs TP laterally arranged in five columns using the magazine units 100; a unit image UPb representing a state of use having the tray units 200 vertically loaded in two layers, each tray unit 200 having the cigarette packs TP laterally arranged in five columns using the magazine units 100; a unit image UPc representing a state of use having the tray units 200 vertically loaded in three layers, each tray unit 200 having the cigarette packs TP laterally arranged in three columns using the magazine units 100; and a unit image UPd representing a state of use having the tray units 200 vertically loaded in two layers, each tray unit 200 having the cigarette packs TP laterally arranged in three columns using the magazine units 100.

Besides the style of accommodation of the cigarette packs TP in the magazine units 100 loaded on the frame units 300 with the aid of the tray units 200 as described in the above, the cigarette display system 1000 may also accommodate the cigarette cartons TK in the tray units 200 loaded on the frame units 300, while aligning the longitudinal direction of the cartons in the depth-wise direction or in the lateral direction, as illustrated in FIG. 4 to FIG. 6. In other words, the cigarette display system 1000 allows several styles of use of the frame units 300.

Therefore in the data processing device 800 of this embodiment, also a plurality of types of unit images UPe, UPf and so forth, given with graphics correspondent to the plurality of styles of use as illustrated in FIG. 8 and FIG. 9, are respectively set to the corresponding unit data UD.

In the cigarette display system 1000, simple fittings EF for carrying box packs BP, for example, can also be directly placed on the frame units 300 or the tray units 200, as illustrated in FIG. 4 and FIG. 6.

Alternatively, in the cigarette display system 1000, the box packs BP and so forth may be displayed using a mesh unit 450 freely attachable and detachable to and from the frame unit 300, as illustrated in FIG. 7.

Therefore, in the data processing device 800 of this embodiment, also a unit image UPg modeled after the above-described simple fitting EF as illustrated in FIG. 10(a), and a unit image UPh modeled after the mesh unit 450 as illustrated in FIG. 10(b) are respectively set to the corresponding unit data UD.

In addition, also a plurality of unit images UP modeled after the front geometry of the stocker unit 400 as illustrated in FIG. 11, and the unit images UP of a plurality of table units 410 modeled after the front geometry of the table units 410 as illustrated in FIG. 12, are respectively set to the corresponding unit data UD.

Also the stocker units 400 are available in four types based on combinations of two types of lateral dimension and two types of vertical dimension. Accordingly, the unit images UP of the stocker units 400 also appear as unit images UPi to UPl based on combinations of two types of lateral dimension and two types vertical dimension, as illustrated in FIG. 11.

Similarly, since the table units 410 are available in two types of lateral dimension, so that the unit images UP of the table units 410 also appear as unit images UPm and UPn having two types of lateral dimension, as illustrated in FIG. 12.

Alternatively, the cigarette display system 1000 can also be installed over the sales counter (not illustrated) of a shop, as described in the above. The data storage unit 810 therefore also stores a sales counter image CP modeled after the front geometry of the sales counter on the same scale of reduction with the unit image UP, as illustrated in FIG. 13.

In the data processing device 800 of this embodiment, the layout storage unit 811 stores the layout data LD preliminarily entered by the supplier or the like of the cigarette packs TP. Details will be described later.

Accordingly, the image display unit 812 allows thereon layout of the various unit images UPa to UPn and the sales counter image CP and so forth corresponding to the layout data, and allows them to be output to be displayed in a dedicated layout window LW on the screen.

In addition, typically alongside of the above-described layout window LW, a plurality of unit images UPa to UPn, the sales counter image CP and so forth are displayed as samples. The layout window LW typically displays a grid having each edge representing 10 cm.

The unit layout unit 814 modifies the layout of the unit images UP and the sales counter image CP, corresponding to the detected layout operation, while keeping the plurality of unit images UP output to be displayed in an arranged manner as described in the above.

The data storage unit 810 stores also a person image, an image of a person, PP modeled after the front geometry of a person on the same scale of reduction with the unit image UP, as illustrated in FIG. 14. Accordingly, the image display unit 812 also outputs the person image PP to be displayed on the screen, as illustrated in FIG. 3.

The operation detection unit 813 therefore also detects a layout operation of the person image PP. The unit layout unit 814 arranges the person image PP in front of, or alongside of the already-arranged unit images UP, corresponding to a detected layout operation.

The above-described person image PP is composed of a main body portion PPa modeled after the head, trunk and legs of a worker, and a pair of upper limb portions PPb modeled after the upper limb of a person. The pair of upper limb portions PPb are made freely rotatable around positions corresponding to the shoulder portions of the main body portion PPa.

The operation detection unit 813 also detects an input operation for rotating the upper limb portions PPb of the person image PP output for display. The image display unit 812 displays the person image PP, with the upper limb portions PPb of which being rotated according to an input operation.

According to the data processing device 800 of this embodiment, as illustrated in FIG. 1, the unit data UD stored by the above-described data storage unit 810 further includes required time as the work load, set together with the unit images UP, and lateral occupied dimensions which represent occupied dimensions in the lateral direction and vertical occupied dimensions which represent occupied dimensions in the vertical direction for each of the plurality of types of frame units 300.

Accordingly, the result calculation unit 816 respectively calculates also a total of the lateral occupied dimension, a total of the vertical occupied dimension, and a total of the required time, corresponding to the layout of the unit images UP, and the result output unit 817 outputs also thus-calculated totals of the lateral occupied dimension, the vertical occupied dimension, and the required time to be displayed.

Note that the above-described vertical and lateral occupied dimensions are typically composed of the outer vertical and lateral dimensions of the frame units 300. The above-described required time is set typically corresponding to an average time required for attachment/detachment of each of the correspondent frame units 300.

Accordingly, the above-described required time is typically set to 5 minutes for the unit data UD which represents a three-row-five-column large frame unit 300 as illustrated in FIG. 8(a), and set to 3 minutes for a unit data UD which represents a two-row-three-column small frame unit 300 as illustrated in FIG. 8(d).

The data processing device 800 of this embodiment has, in addition to the above-described components 810 to 817, a time input unit 821 which accepts input operations of scheduled time, a time storage unit 822 which temporarily holds thus-entered scheduled time, and an alarm unit 823 which outputs an alarm when thus-calculated total of required time exceeds the temporarily-held scheduled time, as illustrated in FIG. 1.

Still further, the data processing device 800 of this embodiment has a left/right value input unit 825 which accepts input operations of the planned lateral dimensions which represent the planned dimensions in the lateral direction, a left/right value storage unit 826 temporarily holding thus-entered planned lateral dimensions, a top/bottom value input unit 827 accepting input operations of the planned vertical dimensions which represent the planned dimensions in the vertical direction, and a top/bottom value storage unit 828 temporarily holding thus-entered planned vertical dimensions.

Accordingly, the alarm unit 823 also outputs an alarm when thus-calculated total occupied dimension in the lateral direction or in the vertical direction exceeds the temporarily-held planned dimension in the same direction.

The above-described output for alarming is executed in such a way that the later-described time margin and the dimensional margin are displayed in red in a flashing manner, associated typically with a balloon sign containing a guidance message given by the display device 801. Details will be described later.

The data storage unit 810 also stores an allowable vertical dimension which represents an allowable dimension of the cigarette display system 1000 in the vertical direction. Accordingly, the alarm unit 823 outputs an alarm also when a thus-calculated vertical occupied dimension exceeds the preliminarily-stored allowable vertical dimension.

The above-described various input units 821, 825 and 827 are displayed on the screen as regions for entry of text data, as illustrated in FIG. 3. Accordingly, the data processing device 800 of this embodiment is also provided with a display unit for current price which represents the above-described total required time, and a display unit for time margin which represents a difference between the scheduled time and the required time, alongside of the time input unit 821.

Similarly, display units for the total lateral dimension and total vertical dimension, and display units for dimension margin which represents differences between the planned dimensions and the current dimensions are respectively provided alongside of the left/right value input unit 825 and the top/bottom value input unit 827.

The plurality of types of frame units 300 of the cigarette display system 1000 can yield combinations of those engageable with each other and combinations of those unengageable with each other in the vertical direction. The data storage unit 810 therefore stores unit data UD set with the combinations of those engageable with each other in the vertical direction, on the basis of the individual types of the frame units 300.

The unit layout unit 814 therefore nullifies any layout operation relevant to the combination of the unit components unengageable with each other in the vertical direction, and the alarm unit 823 outputs an alarm when a layout operation is effected on the combination of unit images UP unengageable with each other in the vertical direction.

The above-described individual sections 810—of the data processing device 800 are logically realized by the computer unit 803 executing various process operations corresponding to the computer program 860 installed thereon as described in the above.

This sort of computer program 860 is offered by a supplier of the cigarette packs TP to the shops, for example, in the form of application software stored in a data storage medium such as a CD-R 852 (not illustrated).

The data processing device 800 at the shop, onto which the above-described computer program 860 is installed as application software, has an OS (Operating System) preliminarily installed thereon. Therefore, the above-described individual sections 810—are actually realized by the cooperative operation of the OS and the application software.

The computer program 860 of the application software is typically composed of a resource set 861 and a program module set 870, as illustrated in FIG. 15.

The resource set 861 contains various data including the unit data UD which is composed of the unit image UP and the required time as described in the above; the sales counter image CP; the person image PP; allowable vertical dimension, and so forth.

The program module set 870 contains various program modules, including a storage process module 871 which makes the data processing device 800 execute unit storage processing of storing the unit data UD, which is composed of unit images UP modeled after the front geometries on a predetermined scale of reduction, set together with the occupied dimensions in the lateral and vertical dimensions, the required time and so forth, on the basis of the individual types of the frame units 300, and layout storage processing of storing layout data LD of a plurality of frame units 300 and so forth composing the cigarette display system 1000; a display process module 872 which makes the data processing device 800 execute an image display processing of outputting a plurality of unit images UP to be displayed on the screen, according to a layout corresponded to the stored layout data LD; a detection process module 873 which makes the data processing device 800 execute operation detection processing of detecting layout operations effected through the input device 802 on the unit images UP output for display; a layout process module 874 which makes the data processing device 800 execute unit layout processing of modifying the layout of the unit images UP output for display on the screen of the display device 801, corresponding to any detected layout operation; a calculation process module 875 which makes the data processing device 800 execute result calculation processing of calculating a total of the occupied dimensions and a total of the required time, corresponding to the layout of the unit images UP; and an output process module 876 which makes the data processing device 800 execute result output processing of outputting the thus-calculated total of occupied dimensions and the total of required time to be displayed on the screen.

Methods of using the data processing device 800 of this embodiment and the cigarette display system 1000 configured as described in the above will be explained below. First, the cigarette display system 1000 of this embodiment may be configured, depending on needs, by freely combining four types of frame unit 300, four types of tray unit 200, two types of magazine unit 100 and so forth.

Accordingly, the cigarette display system 1000 of this embodiment may have an appearance adapted to the installation space, so as to ensure an effective use of space. In particular, by virtue of using the narrow frame unit 300 capable of accommodating the cigarette packs TP in three columns, and the wide frame units 300 capable of accommodating the cigarette packs TP in five columns, the cigarette display system 1000 can be well adaptable to the lateral dimension of the installation space.

In addition, by virtue of using the tall frame units 300 capable of holding the cigarette packs TP in three rows, and the short frame units 300 capable of holding them in two rows, the cigarette display system 1000 can be well adaptable also to the vertical dimension of the installation space.

For example, the shop which wishes to introduce the cigarette display system 1000 measures the vertical and lateral dimensions of the space for installation, and sends the results together with a desired number of cigarette packs TP to be displayed, a desired total number of cigarette packs TP to be accommodated and so forth, to the supplier.

The supplier then creates the layout data LD of the cigarette display system 1000, adapted to the space for installation and requirements of the shop, typically by using a system (not illustrated) similar to the data processing device 800.

The layout data LD is then stored together with the above-described application software into the CD-R 852. In addition, image data which expresses the unit images UP arranged corresponding to the layout data LD is printed out as an assembly manual (not illustrated) of the cigarette display system 1000.

The supplier then provides the shop with various frame units 300 and so forth, corresponded to thus-created layout data LD, together with the above-described CD-R 852 and the assembly manual. At the shop, the cigarette display system 1000 is organized using the various frame units 300 and so forth, while referring to the supplied assembly manual.

Unlike the conventional system frame (not illustrated) having a fixed structure, thus-organized cigarette display system 1000 is fully adaptable to various requirements of the shops, including dimensions of the sales floor, the number of display and the number of accommodation of the cigarette packs TP. As a consequence, the best sales floor may be configured.

The requirements of the shop, such as those on the dimension of sales floor, the number of display and the number of accommodation of the cigarette packs TP and so forth, may vary when the shop having the cigarette display system 1000 introduced therein is in need of renewal.

Even in such a case, unlike the conventional system frame (not illustrated) having a fixed structure, the cigarette display system 1000 may be adaptable to requirements of the shop, through the structural modification based on re-assembling of the frame units 300.

A less-skilled worker may, however, feel a great difficulty in the structural modification of the cigarette display system 1000, due to an extremely large degree of freedom of its structure. For this reason, it may be recommendable for the shop, under planning of the structural modification of the cigarette display system 1000, to fully examine the layout of the frame units 300.

The cigarette display system 1000 also allows re-assembling of the various frame units 300 in various ways. Therefore, the required time for the structural modification of the cigarette display system 1000 may not always be the same.

For this reason, the structural modification of the cigarette display system 1000 in a try-and-error manner by a less-skilled worker may result in waste of time. The structural modification of the cigarette display system 1000 may preferably be preceded by preliminary confirmation of the required time corresponding to details of the task.

The worker at the shop, under planning of the structural modification of the cigarette display system 1000, then loads the CD-R 852 provided by the supplier on a computer device owned by the shop, installs the computer program 860, and activate the computer program 860 so as to allow the computer device to function as the data processing device 800.

Then in the data processing device 800, the individual unit images UPa to UPn, the sales counter image CP, the person image PP, the layout window LW, the input unit 821 for the various times, the input units 825, 827 and display unit for the various dimensions and so forth are output to be displayed on the screen of the display device 801, as illustrated in FIG. 3 and FIG. 16 (step S1).

On the initial screen in this process, the layout window LW, the input units 821, 825, 827, display units for the times and dimensions and so forth appear blank. Also a mouse cursor MC is output to be displayed on the screen, as a result of cooperative operation of the above-described computer program 860 and the OS.

For example, when a read-out of the layout data LD is designated in this state by a predetermined operation (step S2), the layout data LD is read out, and various unit images UP are output to be displayed in the layout window LW on the screen of the display device 801, according to a layout corresponded to the layout data, as illustrated in FIG. 3 (step S3).

In an exemplary case of structural modification for the first time of the cigarette display system 1000 provided by the supplier as described in the above, there is only a single entry of the layout data LD in the CD-R 852, so that this layout data LD is designated and read out.

In this case, the layout window LW on the screen of the display device 801 will have a schematic image of the cigarette display system 1000 provided by the supplier and actually installed at the shop.

If the worker makes, depending on needs, input operations of the scheduled time for structural modification, and planned vertical and lateral dimensions through the input device 802 into the input units 821, 825, and 827 (steps S4 to S6), the entry data are held and output to be displayed to the input units 821, 825, 827 (steps S7 to S9).

For example, if the scheduled time for the structural modification of the cigarette display system 1000 at the shop is two hours, a text data of “2 hr 00 min” is entered by an input operation through the input device 802, and then output to be displayed.

When the planned lateral dimension of the new installation space of the cigarette display system 1000 in the shop is 120 cm, a text data of “120” is entered by an input operation to the left/right value input unit 825, and then output to be displayed.

Similarly, when the planned vertical dimension of the new installation space of the cigarette display system 1000 in the shop is 140 cm, a text data of “140” is entered by an input operation to the top/bottom value input unit 827, and then output to be displayed.

When the worker optionally makes a layout operation of the unit images UP and the sales counter image CP output for display in the layout window LW, typically by a drag-and-drop operation using the mouse cursor MC, the data processing device 800 which detects this operation (step S10) then judges whether the layout operation is appropriate or not (step S11).

For example, as illustrated in FIG. 3, the unit images UP of the frame units 300 and the stocker units 400, and the sales counter image CP may be arranged at the lowermost portion of the layout window LW.

In addition, the unit image UP of the stocker unit 400 may be arranged right above the unit image UP of the stocker unit 400. Also the unit images UP of the table unit 410 and the frame unit 300 may be arranged right above the unit image UP of the stocker unit 400 and the sales counter image CP. The unit image UP of the frame unit 300 may be arranged right above the unit image UP of the frame unit 300.

It is, however, not permissible to arrange the sales counter image CP anywhere other than the lowermost portion. It is also not permissible to arrange the unit image UP of the stocker unit 400 right above the unit image UP of the frame unit 300.

The unit image UP of the table unit 410 cannot be arranged anywhere other than the intermediate region between the unit images UP of the sales counter image CP or the stocker units 400 and the unit image UP of the frame unit 300. The above-described limitations on the layout are set typically as attribute data, respectively to the unit data UD, the sales counter image CP and so forth.

Accordingly, if any impossible layout operation is executed by the worker (step S11-N), such a layout operation is ignored, and a layout alarm with a guidance message such as “Impossible layout. This unit is . . . ”, for example, is output to be alarmed typically in a form of balloon (step S12).

On the other hand, when any possible layout operation is executed by the worker (step S11-Y), a layout data is produced corresponding to the layout operation, and the sales counter image CP and the unit images UP are displayed in an arranged form in the layout window LW (step S13).

When the layout operation is made on the unit images UP and so forth output for display in the layout window LW as described in the above, any unnecessary unit images UP, for example, may temporarily be disposed in the blank portion or outside of the layout window LW.

If the unit images UP of all frame units 300 of the cigarette display system 1000 owned by the shop are output to be displayed in the layout window LW, this means that there is no frame unit 300, addable to the cigarette display system 1000 based on such layout, available in the shop.

Therefore, any unit image UP outside the layout window LW appears dark, and the darkened unit image UP is not arrangeable in the layout window LW.

Accordingly, when the layout operation of the unit images UP is attempted in the layout window LW, beyond the range of the types and quantity of the frame units 300 owned by the shop, the data processing device 800 outputs, as a layout alarm, a guidance message such as “The unit not in your stock. Buy it now, if necessary. Place your order to . . . ”, or “All units in use in the current layout. Buy it now, if necessary. Place your order to . . . ” or the like is output to be displayed, typically in a form of balloon sign (step S12).

On the other hand, if any unit image UP output to be displayed in the layout window LW is brought outside by a layout operation, the correspondent unit image UP is highlighted. This indicates that the frame unit 300 correspondent to the highlighted unit image UP is available in the shop.

Therefore, any unit image UP highlighted outside the layout window LW may be arranged in the layout window LW. Note that the sales counter is an installation at the shop, and is not a kind of provision from the supplier, so that the sales counter image CP always appears highlighted and may be arranged in the layout window LW.

According to the data processing device 800 of this embodiment, for example, the sales counter image CP arranged by the layout operation as described in the above may be expanded or shrunk in the lateral direction typically by an input operation through the input device 802. The sales counter image CP may be corresponded to the sales counter actually installed at the shop.

The layout window LW is variable in the vertical and lateral dimensions, typically through an input operation again using the mouse cursor MC. The unit images UP arranged in the layout window LW are output for display on the scale of reduction corresponding to the layout window LW.

In the data processing device 800 of this embodiment, also the person image PP may be arranged in the layout window LW as illustrated in FIG. 3, through a process operation independent from the above-described layout operation of the unit images UP.

In this case, the upper limb portions PPb of the person image PP may be rotated by operation, depending on needs. Accordingly, the unit images UP may be arranged while making comparison with standard stature and working range of the worker.

Once the unit images UP are arranged in the layout window LW as described in the above, the required times, or the work load, of the unit data UD correspondent to the unit images UP are summed up.

In addition, the lateral dimension and vertical dimension of the unit data UD are respectively summed up corresponding to the layout of the unit images UP, and thereby a current lateral dimension and a current vertical dimension are calculated (step S14). The required time, the current lateral dimension, and the current vertical dimension thus calculated are output for display (step S15).

For an exemplary case where the unit images UP of the frame unit 300 respectively characterized by a required time of 5 minutes, a lateral dimension of 35 cm and a vertical dimension of 25 cm are arranged in three columns in the lateral direction, and in six rows in the vertical direction, a text data of “1 hr 30 min” appears in the display unit for the required time in adjacent to the time input unit 821, a text data of “105” appears in the display unit for the current lateral dimension in adjacent to the left/right value input unit 825, and a text data of “150” appears in the display unit for the current vertical dimension in adjacent to the top/bottom value input unit 827.

For the case where the scheduled time is entered by an input operation and temporarily held as described in the above (step S16), a time margin is calculated as a result of subtraction of the required time from the scheduled time (step S17).

If the time margin falls on a positive value (step S18-N), the time margin can be output for display as it is (step S20). On the other hand, if the time margin falls on a negative value (step S18-Y), the time margin can typically be displayed in red in a flashing manner, associated with a balloon sign containing a guidance message such as “Time exceeded.”, output as a time alarm (step S19).

For another exemplary case, as illustrated in FIG. 17, where the planned lateral dimension is entered by an input operation and temporarily held as described in the above (step S21-Y), a lateral dimensional margin is calculated as a result of subtraction of the current lateral dimension from the planned lateral dimension (step S22).

If the lateral dimensional margin falls on a positive value (step S23-N), the lateral dimensional margin can be output to be displayed as it is (step S25). On the other hand, if the lateral dimensional margin falls on a negative value (step S23-Y), the lateral dimensional margin can typically be displayed in red in a flashing manner, associated with a balloon sign containing a guidance message such as “Laterally oversized beyond planned value.”, output as a lateral value alarm (step S24).

The current vertical dimension is judged whether it exceeds the allowable vertical dimension (step S26), and if it is found to exceed, the current vertical dimension is displayed in red in a flashing manner, associated with a balloon sign containing a guidance message such as “Vertically oversized beyond safety range.”, output as a left/right value alarm (step S30).

On the other hand, if the current vertical dimension is not found to exceed the allowable vertical dimension (step S26-N), and if the planned vertical dimension is preliminarily entered by an input operation and temporarily held as described in the above (step S27-Y), a vertical dimensional margin is calculated as a result of subtraction of the current vertical dimension from the planned vertical dimension (step S28).

If the vertical dimensional margin falls on a positive value (step S29-N), the vertical dimensional margin can be output for display as it is (step S31). On the other hand, if the vertical dimensional margin falls on a negative value (step S29-Y), the vertical dimensional margin can typically be displayed in red in a flashing manner, associated with a balloon sign containing a guidance message such as “Vertically oversized beyond planned value.”, output as a vertical value alarm (step S30).

For an exemplary case where the layout operation yields calculated values of a required time of “01 hr 30 min”, a current lateral dimension of “105”, and a current vertical dimension of “150”, while the scheduled time is preliminarily set to “02 hr 00 min”, the planned lateral dimension to “120”, and the planned vertical dimension to “140” as described in the above, a time margin of “00 hr 30 min” and a lateral dimensional margin of “15” are output to be displayed as positive values, whereas the vertical dimensional margin appears as a negative value of “−10” in red in a flashing manner, associated with the alarm guidance.

Even if the alarms relevant to the time and dimension are once output for display as described in the above, it is also possible to make the alarm no longer be output (steps S14 to S31), by re-entering the scheduled time and the planned dimension (steps S4 to S9), or by modifying the layout of the unit images UP (steps S10 to S13), as illustrated in FIG. 16.

Even for an exemplary case where the unit images UP of the frame units 300 each having a vertical dimension of 25 cm are vertically arranged in six rows, thereby to give a current vertical dimension of “150” and a vertical dimensional margin of “−10”, while the planned vertical dimension is set to “140” as described in the above, deletion of the topmost unit image UP causes the current vertical dimension to be reduced to “125” and the vertical dimensional margin to be increased to “15”, with the alarm guidance then disappearing.

If the reset icon on the screen is entered by an input operation (step S32-Y), thus-entered scheduled time, thus-arranged unit images UP and so forth are reset (step S33).

The worker, who is successful in establishing a desired layout of the unit images UP as a result of the input operation as described in the above, may typically print out the image displayed in the layout window LW by a predetermined operation (not illustrated).

In this case, the structural modification of the cigarette display system 1000 is carried out at the shop, referring to the printed result. Since the time required for the structural modification is preliminarily confirmed, the structural modification of the cigarette display system 1000 may deliberately be carried out.

The worker, who was successful in establishing a desired layout of the unit images UP using the data processing device 800 as described in the above, may also make an input operation on the “Save” icon.

Then as illustrated in FIG. 17, the data processing device 800 which detects the input operation (step S34) stores a new layout data LD together, for example, with the current date and time, a serial number and so forth (step S35).

Accordingly, when the cigarette display system 1000 organized corresponding to the above-described new layout is structurally modified again, the above-described new layout data LD may be designated (step S2) so as to modify the layout of the unit images UP (step S4 to S35).

The cigarette display system 1000 of this embodiment may freely be modified in the dimensions in the vertical and lateral directions and so forth, by freely re-assembling a plurality of types of frame units 300 at the shop, as described in the above.

Accordingly, a new sales floor may ideally be configured, even for the case of renewal of the shop. This means, however, that the any shop making use of the cigarette display system 1000 is requested to determine a layout of the frame units 300 and so forth, so as to adapt them to the vertical and lateral dimensions of the new place of installation.

In addition, any shop under planning to structurally modify the cigarette display system 1000 has to consider also the required time which depends on details of the structural modification. The cigarette display system 1000 is, however, extremely large in the degree of freedom of layout of the frame units 300 and so forth. It may, therefore, be not easy to determine an optimum layout, while taking even the overall occupied dimension and the required time for the structural modification into consideration.

In contrast, according to the data processing device 800 of this embodiment, the current structure of the cigarette display system 1000 may be reproduced by a plurality of unit images UP and output to be displayed as described in the above, and the unit images UP output for display may be arranged by the layout operation through the input device 802.

Accordingly, the new configuration may preliminarily and extensively be examined, and an optimum new configuration may be created, even when the cigarette display system 1000 is structurally modified typically for the purpose of renewal of the shop.

Moreover, the actual work load of the structural modification of the cigarette display system 1000 may be calculated as a result of the layout operation of the unit images UP, and output to be displayed. Accordingly, the work load of the structural modification may also preliminarily and readily be confirmed, when the cigarette display system 1000 is structurally modified.

In particular, the data processing device 800 calculates the required time as the work load of the structural modification of the cigarette display system 1000, and outputs it to displayed. Accordingly, the shop is now capable of structurally modifying the cigarette display system 1000 deliberately at a desired time.

Shops such as convenience stores are limited in time for the individual types of tasks. Accordingly, if the shops having the cigarette display system 1000 installed therein are convenience stores, it is important to preliminarily confirm the required time for the structural modification.

Moreover, the data processing device 800 calculates the total required time and outputs it for display, every time the layout operation of the unit images UP takes place. The worker can therefore confirm the required time for the structural modification in real time, while executing the layout operation of desired unit images UP. Accordingly, a new configuration obtainable after modification within a limited duration of time can readily be created.

In particular, the data processing device 800 allows input of the scheduled time at the worker's will, and displays the required time alongside of the scheduled time. Also the time margin calculated by subtracting the required time from the scheduled time is displayed alongside thereof.

Accordingly, the worker can compare the required time with the scheduled time in real time, while arranging any desired unit images UP, and can therefore confirm the time margin in real time.

In particular, when the time margin falls on a negative value, the time alarm is output. The worker can therefore confirm that the required time exceeded the scheduled time, in the process of arranging the unit images UP.

Modification of the layout of the unit images UP or edition of the scheduled time can be allowable even when the time alarm remains active, and output of the time alarm is cleared when the time margin falls on a positive value.

Accordingly, the worker can examine, for example, the layout of the frame units 300 modifiable within the scheduled time, and the required time for the structural modification of the desired cigarette display system 1000 in real time.

The data processing device 800 of this embodiment calculates the occupied dimension of the actual cigarette display system 1000, and outputs it to be displayed, every time the layout operation of the unit images UP takes place.

Accordingly, the dimensions necessary for the installation can be confirmed in real time, while arranging the desired unit images UP by the layout operation. Therefore, the tasks for organizing the cigarette display system 1000, capable of making the best use of the space for newly installation at the shop, can be assisted in a successful manner. In particular, since the occupied dimensions can be calculated independently in the vertical direction and in the lateral direction, so that a layout best matched to the new installation space can be examined.

Also the planned vertical and lateral dimensions can be entered by the input operation at the worker's will, wherein the current vertical and lateral dimensions are output to be displayed alongside of the planned dimensions. Moreover, the dimensional margins calculated by subtracting the current dimensions from the planned dimensions can further be output for display alongside thereof.

Accordingly, the worker can compare the occupied dimensions with the planned dimensions in real time, while arranging any desired unit images UP by the layout operation, and can thereby confirm the dimensional margins in real time.

In particular, a dimensional alarm is output when the dimensional margin falls on a negative value. The worker can therefore confirm that the current dimension exceeded the planned dimension in real time, while arranging the unit images UP by the layout operation.

Modification of the layout of the unit images UP or edition of the planned dimension can be allowable even when the dimensional alarm remains active in this manner, and output of the dimensional alarm is cleared when the dimensional margin falls on a positive value.

Accordingly, the worker can examine the layout of the frame units 300 installable on site without causing any problems, and the space necessary for installing the desired cigarette display system 1000 in real time.

The data processing device 800 also stores allowable vertical dimensions which are preliminarily determined from the viewpoint of safety, besides the planned vertical dimension freely set by the worker. Therefore, a specialized dimensional alarm is output when the current vertical dimensions exceed the allowable vertical dimensions, even though the planned vertical dimensions are not exceeded.

Therefore, the safe vertical dimensions of the cigarette display system 1000 can readily and exactly be recognized by the worker, and thereby the cigarette display system 1000 is prevented from being used after being organized to have dangerous dimensions.

The plurality of types of frame units 300 and so forth of the cigarette display system 1000 can yield combinations of those engageable with each other and combinations of those unengageable with each other in the vertical direction. The data processing device 800 therefore nullifies any layout operation for the combinations of the unit images UP unengageable with each other in the vertical direction, and outputs a layout alarm for alarming when a layout operation is effected on the combinations of unit images UP unengageable with each other in the vertical direction.

Therefore, the combinations of the frame units 300 and so forth unengageable can readily and exactly be recognized by the worker, and thereby the cigarette display system 1000 is prevented from being used after being organized to have dangerous structure.

Accordingly, the worker may determine an optimum layout of the frame units 300 and so forth, taking also the overall occupied dimension of the cigarette display system 1000 and the work load into consideration. Therefore, the data processing device 800 may successfully assist the task such as modifying the cigarette display system 1000 to have the optimum new configuration with a minimum work load.

The cigarette display system 1000 is often installed over the top surface of the sales counter of the shop. The data processing device 800 allows the layout operation, while outputting also the sales counter image CP, modeled after the front geometry of the sales counter on the same scale of reduction with the unit images UP, to be displayed on the screen. The worker can therefore readily confirm a finished image of the cigarette display system 1000, also for the case where it is installed over the sales counter.

In particular, if the sales counter image CP is arranged together with the unit images UP by the layout operation as described in the above, the vertical dimension of the sales counter can be reflected on the vertical dimension of the cigarette display system 1000, while leaving the lateral dimension and the required time not reflected thereon. Accordingly, only information which is necessary to be examined can be provided to the worker, when the cigarette display system 1000 is planned to be installed over the sales counter.

Moreover, since the unit images UP are modeled after the front geometry of the plurality of types of frame units 300 and so forth, the worker may confirm the final image so forth of the cigarette display system 1000 by intuition.

In the cigarette display system 1000, display styles of the cigarette packs TP, the cigarette cartons KT and so forth are designated on the basis of the individual types of the frame units 300. The data processing device 800 allows the layout operation while outputting and displaying the unit images UP modeled after the display style. The worker can, therefore, readily and exactly confirm different display styles of the cigarette packs TP and so forth on the frame units 300 of the same dimension.

In the cigarette display system 1000, the simple fittings EF such as the box packs BP can directly be placed on the frame units 300 and the tray units 200. Also the mesh unit 450, for example, can be adoptable.

The data processing device 800 can, however, allow the layout operation while outputting and displaying also the unit images UPa to UPh having graphics of the above-described plurality of types of display styles. The worker can, therefore, readily confirm a finished image of the cigarette display system 1000, even for the case where the individual unit 450 and so forth are used.

The data processing device 800 of this embodiment allows the layout operation, while outputting and displaying also the person image PP modeled after the front geometry of a person on the same scale of reduction with the unit images UP on the screen.

The worker can, therefore, confirm also whether the vertical dimension of the structurally-modified cigarette display system 1000 is excessive or not, and can thereby confirm the overall dimension and so forth of the cigarette display system 1000 by intuition.

In particular, the person image PP allows rotation of the upper limb portions PPb thereof by the input operation. The worker can, therefore, readily and exactly confirm whether the vertical dimension of the structurally-modified cigarette display system 1000 is appropriate or not.

The person image PP has a pair of left and right upper limb portions PPb. It can therefore be possible also to confirm, for example, whether the lateral dimension of the structurally-modified cigarette display system 1000 is appropriate, typically by horizontally placing the left and right upper limb portions PPb of the person image PP.

Note that the present invention is not limited to this embodiment, instead allowing various modifications without departing from the spirit thereof. For example, the embodiment in the above shows an exemplary case where the cigarette display system 1000 has the frame units 300 as the unit components, and the data processing device 800 is correspondingly formed.

The cigarette display system 1000 may alternatively have a wall unit 500 as the unit component. In this case, as illustrated in FIG. 18, the cigarette display system 1000 may be built using the wall unit 500, without using the frame units 300.

The wall unit 500 is configured by a base wall 500a and a panel wall 500b, as illustrated in FIG. 19. A plurality of panel walls 500b can be engaged in the vertical direction, and can be engaged with the upper end of the base wall 500a.

Thus, the wall unit 500 having a desired vertical dimension can be formed. The tray unit 200 may be attached to the wall unit 500 using a tray attachment 600.

The cigarette display system 1000 can be configured to have a desired vertical dimension by engaging a plurality of wall units 500 in the vertical direction, and also to have a desired lateral dimension by arranging the wall units 500 in the lateral direction.

The tray attachments 600 may be attached at desired positions on the front faces of the wall units 500 arranged in the vertical and lateral directions as described in the above, so as to allow the tray attachments 600 to hold the tray units 200. Each tray unit 200 may directly accommodate the cigarette cartons TK, or may accommodate the cigarette packs TP making use of the magazine units 100.

Still further, as illustrated in FIG. 18, the wall units 500 arranged in the vertical and lateral directions as described in the above may be installed on the top surfaces of the stocker units 400 arranged in the vertical and lateral directions, together with the table units 410 and so forth.

Still alternatively, a system built up with the wall units 500 and a system built up with the frame units 300 may be installed side-by-side to configure the cigarette display system 1000 (not illustrated).

The data processing device 800 may output a unit image modeled after the front geometry of the wall unit 500 on the above-described scale of reduction, to be displayed on the screen so as to allow the layout operation (not illustrated).

The embodiment in the above shows an exemplary case where the cigarette display system 1000 is built using structural components such as the frame units 300, and the unit images UP of the frame units 300 and so forth are output, by the displayed data processing device 800, to be displayed so as to allow the layout operation.

The cigarette display system 1000 may, however, have a plurality of types of advertising components 420 attached inside and outside the combined frame units 300, as illustrated in FIG. 20.

Therefore, the data processing device 800 may allow the layout operation, while outputting for display also advertising component data which contains advertising component images modeled after the front geometries of the advertising components 420 on the same scale of reduction with the unit images UP, set together with at least required time on the basis of the individual types of the plurality of advertising components 420, and may calculate the total required time corresponding to thus-arranged unit images UP and the advertising component images. In this case, the shop may examine structural modification of the cigarette display system 1000, taking also the advertising components 420 into consideration.

The embodiment in the above was on the premise of simply setting, on the unit data UD basis, the required time as the work load of the structural modification of the frame units 300 and so forth. Alternatively, the data storage unit 810 may store, for each combination of a plurality of types of frame units 300 and so forth, the unit data UD which includes the required time for the attachment/detachment as the work load, and the result calculation unit 816 may calculate, as the work load, a total of the required time for combining the frame units 300 and so forth, modified in the layout. In this case, the required time may more accurately be calculated, with some increased complexity in data processing by the data processing device 800.

The embodiment in the above describes exemplary case where the data processing device 800 calculates the required time for a single worker as the work load. Alternatively, the data processing device further includes a number-of-persons input unit which accepts an input operation of the number of persons concerning with the structural modification, and a number-of-persons storage unit which temporarily stores the input number of persons, wherein the result calculation unit 816 may divide the total of the required time by the number of persons (not illustrated).

In this case, if the number of workers is given, the required time under such number of workers may be calculated by the data processing device, so that the structural modification of the cigarette display system 1000 may be proceeded in a more deliberate manner.

However, the number of workers optimum for the structural modification of the cigarette display system 1000 may be limitative in practice. For example, if 1000 workers should concern with the structural modification of the cigarette display system 1000, the required time would not be reduced to 1/1000 of the time required by a single worker.

The number-of-persons input unit may therefore be configured to accept an operation of selecting the number of persons only from a plurality of predetermined varieties. In this case, the number of persons for the structural modification of the cigarette display system 1000 maybe selectable typically from “one, two, . . . five” output to be displayed as an optimum number of workers, so as to prevent any inappropriate required time from being output, as a result of an input operation of any non-realistic number of workers.

Still alternatively, a display unit may be provided corresponding to each of the above-described plurality of varieties of the number of persons, so as to allow therein output of an message of “×× hr ×× min necessary for a one-person operation”, “×× hr ×× min necessary for two-person operation”, or the like.

The embodiment in the above describes an exemplary case where the first layout data LD is created by the supplier and provided to the shop, when the cigarette display system 1000 is newly introduced to the shop from the supplier.

Alternatively, the shop under planning of introduction of the cigarette display system 1000 may be provided with the above-described application software from the supplier, and may create the first layout data LD using the data processing device 800 installed with the application software.

In this case, the frame units 300 and so forth may be provided corresponding to the layout data LD from the supplier to the shop, and the cigarette display system 1000 is organized at the shop using the frame units 300 and so forth.

The embodiment in the above is on the premise of using all available frame units 300 and so forth for the structural modification of the cigarette display system 1000, for simplicity of explanation. However, in the actual structural modification, a part of the frame units 300 may be disused and stocked in the back yard.

Therefore, in this case, the data processing device 800 may be allowed to recognize the frame unit 300 in stock, and to highlight the unit images UP disposed outside the layout window LW as described in the above, in the structural modification for the next time.

In this case, any frame units 300 addable to the current cigarette display system 1000 may be recognized by the worker at a glance, and the unit images UP thereof may be arranged in the layout window LW so as to make themselves readily adoptable to creation of a new layout.

The above-described embodiment discussed the exemplary case where the unit images UP, having the same dimension but different in the display style of the cigarette packs TP and the cigarette cartons TK, are preliminarily registered to the data processing device 800, and are respectively output for display.

Alternatively, only a single unit image may be displayed for every outer dimension, and a schematic image of a display style inside the unit image can be displayed in a toggled manner corresponding to every input operation. In this case, the examination can be made by changing only the display style of the cigarette packs TP and the cigarette cartons TK without modifying the overall dimension of the arranged unit images.

The above-described embodiment discussed the exemplary case where the unit images UP are given by the schematic images of the display styles. The unit images UP may alternatively be given by photographic data of the actual frame units 300 and so forth, or may be given by the schematic images and photographic data toggled therebetween. In this case, more realistic finished images of the cigarette display system 1000 can be presented to the worker.

The above-described embodiment discussed the exemplary case where only a grid is displayed in the layout window LW. Alternatively, the data processing device may accept input of a photographic data of the shop taken by the worker using a digital camera or the like, and the photographic data may be displayed as a background of the layout window LW. In this case, the worker may be allowed to confirm a state of installation of the cigarette display system 1000 at the shop in a more real manner.

The above-described embodiment discussed the exemplary case where also the sales counter image CP may be arranged similarly to the unit images UP in the layout window LW by the layout operation. Alternatively, the sales counter image CP may be displayed while being toggled between the on/off states at a predetermined position in the layout window LW, corresponding to a predetermined input operation (not illustrated).

The above-described embodiment discusses the exemplary case where only the lateral dimension of the sales counter image CP may be adjustable. Alternatively, the vertical dimension of the sales counter image CP may be made adjustable, corresponding to an input operation of the vertical dimension of the actual sales counter.

It has been made clear also that the degree of interest of the customer depends on the vertical position, with respect to the cigarette display system 1000 having a sufficient vertical dimension as described in the above. The layout window LW may, therefore, be output for display based on a color arrangement corresponding to the degree of interest of the customer.

In this case, for example, a layout operation such as arranging the unit image UPg of the simple fitting EF for accommodating the box packs BP at a position which attracts more interest of the customer, and arranging the unit image UPf of the frame unit 300 for accommodating the cigarette cartons TK at a position which attracts less interest of the customer, may be facilitated.

Moreover, the above-described embodiment discussed the exemplary case where the allowable vertical dimension of the cigarette display system 1000 is preliminarily denoted, and registered to the data processing device 800. Alternatively, the data processing device may further include a stature input unit accepting an input operation of the stature of the worker; a stature storage unit temporarily holding thus-entered stature; and an appropriate value calculation unit calculating an appropriate dimension in the vertical direction from the temporarily-held stature (not illustrated), and may output an non-conformity alarm when thus-calculated total of occupied dimensions exceeds the calculated appropriate dimension. In this case, the worker may readily confirm whether the vertical dimension of the structurally-modified cigarette display system 1000 to be built is appropriate to his or her own stature.

Alternatively, the data processing device having the stature input unit and the stature storage unit as described in the above may further have a person model adjusting unit adjusting the scale of reduction of the person image PP output for display on the screen corresponding to the temporarily-held stature (not illustrated).

In this case, the worker may confirm, by intuition, whether the vertical dimension of the structurally-modified cigarette display system 1000 is appropriate to his or her stature, based on a relative relation between the arranged unit images UP and the person image PP. Moreover, the person image PP having a plurality of types of stature may preliminarily be prepared.

The above-described embodiment assumed the exemplary case where the opaque person image PP may be arranged by the layout operation alongside, or in front of the arranged unit images UP. Alternatively, a semi-transparent person image PP may be output for display, and may be displayed while being toggled between the on/off states, typically by so-called right click on the mouse 845.

The above-described embodiment assumed the exemplary case where the data processing device 800 calculates and outputs for display the work load in real time and the occupied dimension of the cigarette display system 1000 depending on the layout operation of the unit images UP. Alternatively, the data processing device may calculate and output for display the work load and the occupied dimension, when the worker arranges the unit images UP using the layout operation and then submits “enter”.

The operability by the worker may be improved for the case where the calculation and data output are sequentially executed in real time as described in the above, meanwhile the process load of the data processing device may be reduced for the case where they are executed corresponding to the input operation.

Furthermore, at least a part of the plurality of types of frame units 300 is designated with the number of arrangement of the fixed-size cigarette packs TP aligned in the depth-wise direction, as described in the above. While the number of the cigarette packs TP arranged in the vertical and lateral directions in the frame units 300 might be confirmed by the unit images UP, the number arranged in the depth-wise direction cannot be confirmed.

The data processing device may, therefore, store the unit images UP with a description of the number of arrangement (not illustrated). In this case, the number of cigarette packs TP arranged in the depth-wise direction of the frame units 300 may be confirmed by the unit images UP output for display.

The above-described embodiment assumes the exemplary case where the computer program 860, which allows the computer device at the shop to function as the data processing device 800, is supplied in a form of data storage medium such as the CD-R 852 from the supplier. Alternatively, this sort of computer program 860 may be supplied through so-called data communication typically through the Internet.

It can still also be allowable that a service which includes functions equivalent to those obtainable by the above-described data processing device 800 may be offered to a user terminal device such as the computer device at the shop by the data processing device such as a server at the supplier.

In this case, as illustrated in FIG. 21, a data processing device 900 at the supplier offers a web site WS used for assisting structural modification of the above-described cigarette display system 1000, through the Internet IN to a user terminal device UT.

It may be good enough for the data processing device 900 to have at least a data storage unit 910 as the unit storage unit which stores unit data UD including unit images UP modeled after front geometry of each of the plurality of types of frame units 300 and so forth on a predetermined scale of reduction, together with the work load such as required time; a layout storage unit 911 which stores, on the worker basis, a layout data LD of the plurality of frame units 300 and so forth composing the cigarette display system 1000; a login acceptance unit (not illustrated) which accepts login by the worker through the user terminal device on which the web site WS is browsed; an image display unit 920 which outputs the plurality of unit images UP to be displayed on the screen of the web site WS, according to a layout corresponded to the layout data LD of the logged-in worker; an operation detection 930 unit which detects a layout operation effected through the input device on the unit images UP output for display; a unit layout unit 940 which modifies the layout of the unit images UP output for display on the screen, corresponding to the detected layout operation; a result calculation unit 950 which calculates work load of the structural modification of the cigarette display system 1000, corresponding to the modification of layout; and a result output unit 960 which outputs the calculated work load to be displayed on the web site WS.

In this case, the supplier who is going to offer the cigarette display system 1000 to the shop may offer functions for assisting structural modification of the cigarette display system 1000 through the web site WS to the shop.

1. A data processing device used for assisting structural modification of a unit system formed based on an arbitrary combination of a plurality of types of unit components vertically engaged and laterally arranged, comprising:
a display device that outputs various data to be displayed on a screen;
an input device that accepts various input operations;
a unit storage unit that stores unit data including unit images modeled after front geometry of each of said plurality of types of unit components on a predetermined scale of reduction;
a layout storage unit that stores layout data of said plurality of unit components composing said unit system;
an image display unit that outputs said plurality of unit images to be displayed on said screen, according to a layout corresponded to said stored layout data;
an operation detection unit that detects a layout operation that is effected through said input device on said unit images output for display on said screen;
a unit layout unit that modifies the layout of said unit images output for display on said screen, corresponding to the detected layout operation;
a result calculation unit that calculates work load of the structural modification of said unit system, corresponding to said modification of layout; and
a result output unit that outputs said calculated work load to be displayed on said screen.

2. The data processing device as claimed in claim 1,
wherein said unit storage unit stores said unit data including at least required time for attachment/detachment that is respectively set, as said work load, for each of said plurality of types of unit components, and
said result calculation unit calculates, as said work load, a total of said required time for said unit components modified in the layout.

3. The data processing device as claimed in claim 1,
wherein said unit storage unit stores said unit data including required time for attachment/detachment that is respectively set, as said work load, for each combination of said plurality of types of said unit components, and
said result calculation unit calculates, as said work load, a total of said required time for the combination of said unit components modified in the layout.

4. The data processing device as claimed in claim 2, further comprising:
a time input unit that accepts an input operation of scheduled time of said structural modification;
a time storage unit that temporarily stores said input scheduled time; and
an alarm unit that outputs an alarm when the calculated total of said required time exceeds said temporarily stored scheduled time.

5. The data processing device as claimed in claim 2, further comprising:
a number-of-persons input unit that accepts an input operation of the number of persons concerning with the structural modification; and
a number-of-persons storage unit that temporarily stores said input number of persons,
wherein said result calculation unit divides the total of said required time by said number of persons.

6. The data processing device as claimed in claim 5,
wherein said number-of-persons input unit accepts an operation of selecting the number of persons from a predetermined plurality of varieties.

7. The data processing device as claimed in claim 1,
wherein said unit storage unit stores said unit data that further includes at least the occupied dimension in the lateral direction respectively set for each of said plurality of types of unit components,
said result calculation unit further calculates a total of said occupied dimensions in the lateral direction, corresponding to the layout of said unit images, and
said result output unit further outputs the calculated total of said occupied dimensions to be displayed on said screen.

8. The data processing device as claimed in claim 7, further comprising:
a left/right value input unit that accepts an input operation of a planned dimension in the lateral dimension;
a left/right value storage unit that temporarily stores said input planned dimension; and
an alarm unit that outputs an alarm when the calculated total of said occupied dimensions exceeds said temporarily stored planned dimension.

9. The data processing device as claimed in claim 1,
wherein said unit storage unit stores said unit data that further includes at least the occupied dimension in the vertical direction respectively set for each of plurality of types of unit components,
said result calculation unit further calculates a total of said occupied dimensions in the vertical direction, corresponding to the layout of said unit images, and
said result output unit further outputs the calculated total of said occupied dimensions to be displayed on said screen.

10. The data processing device as claimed in claim 9, further comprising:
a top/bottom value input unit that accepts an input operation of a planned dimension in the vertical direction;
a top/bottom value storage unit that temporarily stores said input planned dimension; and
an alarm unit that outputs an alarm when the calculated total of said occupied dimensions exceeds said temporarily stored planned dimension.

11. The data processing device as claimed in claim 9,
wherein said unit storage unit further stores an allowable dimension in the vertical direction of said unit system, and the data processing device further comprises:
an alarm unit that outputs an alarm when the calculated total of said occupied dimensions exceeds said stored allowable dimension.

12. The data processing device as claimed in claim 9, further comprising:
a stature input unit that accepts an input of the stature of a worker;
a stature storage unit that temporarily stores said input stature;
an appropriate value calculation unit that calculates an appropriate dimension in the vertical direction based on said temporarily stored stature; and
an alarm unit that outputs an alarm when the calculated total of said occupied dimensions exceeds said calculated appropriate dimension.

13. The data processing device as claimed in claim 1,
wherein said unit storage unit further stores a person image modeled after a front geometry of a person on the same scale of reduction with said unit images,
said image display unit further outputs said person image to be displayed on said screen,
said operation detection unit further detects a layout operation of said person image, and
said unit layout unit arranges said person image in front of, or alongside of said arranged unit images, corresponding to said detected layout operation.

14. The data processing device as claimed in claim 13,
wherein said unit storage unit stores said person image, having the upper limb portions of which, modeled after the upper limbs of person, freely rotatable around positions corresponded to the shoulder portions of said person, and
said operation detection unit further detects an input operation for rotating said upper limb portions of said person image output for display.

15. The data processing device as claimed in claim 13, further comprising:
a stature input unit that accepts an input of the stature of a worker;
a stature storage unit that temporarily stores said input stature; and
a person model adjusting unit that adjusts the scale of reduction on which said person image is output to be displayed on said screen, corresponding to said temporarily stored stature.

16. The data processing device as claimed in claim 1,
wherein said plurality of types of unit components yield combinations of those engageable with each other and combinations of those unengageable with each other in the vertical direction,
said unit storage unit stores said unit data that further includes the combination of those engageable with each other in the vertical direction for each of said plurality of types of unit components,
said unit layout unit nullifies any layout operation relevant to the combination of said unit components unengageable with each other in the vertical direction, and the data processing device further comprises:
an alarm unit that outputs an alarm when a layout operation is effected on the combination of said unit images unengageable with each other in the vertical direction.

17. The data processing device as claimed in claim 1,
wherein said unit system further includes a plurality of types of advertising components disposed inside or outside of said combined unit components,
said unit storage unit further stores an advertising component data including advertising component images modeled after front geometries of each of said plurality of types of advertising components on the same scale of reduction with said unit images;
said layout storage unit stores a layout data of said unit components and said advertising components composing said unit system,
said image display unit outputs said unit images and said advertising component images to be displayed on said screen, according to a layout corresponded to said stored layout data;
said operation detection unit detects a layout operation effected through said input device on said unit images and said advertising component images output for display,
said unit layout unit modifies the layout of said unit images and said advertising component images output for display on the screen, corresponding to the detected layout operation, and
said result calculation unit calculates said work load, corresponding to the modification of said layout of said unit images and said advertising component images.

18. The data processing device as claimed in claim 1,
wherein said unit system is a commodity display system installed over a sales counter so as to display commodities while being accommodated by each of said unit components,
said unit storage unit further stores a sales counter image modeled after a front geometry of said sales counter on the same scale of reduction with said unit images,
said image display unit further outputs said sales counter image to be displayed on said screen, and
said unit layout unit arranges said unit images above said sales counter image, corresponding to the detected layout operation.

19. The data processing device as claimed in claim 1,
wherein said unit system is a commodity display system that displays commodities, that are at least partially fixed-size commodities, while being accommodated by each of said unit components,
each of said plurality of types of unit components is designated with the display style of said fixed-size commodities,
at least a part of said plurality of types of unit components is designated to have a plurality of types of display styles, and
said unit storage unit stores a plurality of types of said unit images modeled after said plurality of types of said display styles.

20. The data processing device as claimed in claim 18,
wherein said commodities are cigarette packs.

21. A data processing device providing, through the Internet, a user terminal device with a web site used for assisting structural modification of a unit system including a plurality of unit components vertically engaged and laterally arranged, comprising:
a unit storage unit that stores unit data including unit images modeled after front geometries of each of said plurality of types of unit components on a predetermined scale of reduction;
a layout storage unit that stores, on the worker basis, a layout data of each of said plurality of unit components composing said unit system;
a login acceptance unit that accepts login by said worker through said user terminal device on which said web site is browsed;
an image display unit that outputs said plurality of unit images to be displayed on said screen of said web site, according to a layout corresponded to said layout data of said logged-in worker;
an operation detection unit that detects a layout operation effected through said input device on said unit images output for display;
a unit layout unit that modifies the layout of said unit images output for display on said screen, corresponding to the detected layout operation;
a result calculation unit that calculates work load of the structural modification of said unit system, corresponding to said modification of layout; and
a result output unit that outputs said calculated work load to be displayed on said screen.

22. A method for a data processing device including a display device that outputs various data to be displayed on a screen, and an input device that accepts various input operations, said method assisting structural modification of a unit system formed based on an arbitrary combination of a plurality of types of unit components vertically engaged and laterally arranged, said method comprising:
unit storage processing of storing unit data including unit images modeled after front geometry of each of said plurality of types of unit components on a predetermined scale of reduction;
layout storage processing of storing a layout data of said plurality of unit components composing said unit system;
image display processing of outputting said plurality of unit images to be displayed on said screen, according to a layout corresponded to said stored layout data;
operation detection processing of detecting a layout operation effected through said input device on said unit images output for display;
unit layout processing of modifying the layout of said unit images output for display on the screen, corresponding to the detected layout operation;
result calculation processing of calculating work load of the structural modification of said unit system, corresponding to the modification of said layout; and
result output processing of outputting said calculated work load to be displayed on said screen.

23. A method for a data processing device that provides, through the Internet, a user terminal device with a web site used for assisting structural modification of a unit system including a plurality of unit components vertically engaged and laterally arranged, said method comprising:
unit storage processing of storing unit data including unit images modeled after front geometries of each of said plurality of types of unit components on a predetermined scale of reduction;
layout storage processing of storing, on the worker basis, a layout data of each of said plurality of unit components composing said unit system;
login acceptance processing of accepting login by said worker through said user terminal device on which said web site is browsed;
image display processing of outputting said plurality of unit images to be displayed on said screen of said web site, according to a layout corresponded to said layout data of said logged-in worker;
operation detection processing of detecting a layout operation effected through said input device on said unit images output for display;
unit layout processing of modifying the layout of said unit images output for display on said screen, corresponding to the detected layout operation;
result calculation processing of calculating work load of the structural modification of said unit system, corresponding to said modification of layout; and
result output processing of outputting said calculated work load to be displayed on said screen.

24. A computer-readable data storage medium for a data processing device including a display device that outputs various data to be displayed on a screen, and an input device that accepts various input operations, and is used for assisting structural modification of a unit system formed based on an arbitrary combination of a plurality of types of unit components vertically engaged and laterally arranged, said computer-readable data storage medium storing a computer program, executed by a processor, that allows said data processing device to execute:
unit storage processing of storing unit data including unit images modeled after front geometries of each of said plurality of types of unit components on a predetermined scale of reduction;
layout storage processing of storing a layout data of said plurality of unit components composing said unit system;
image display processing of outputting said plurality of unit images to be displayed on said screen, according to a layout corresponded to said stored layout data;
operation detection processing of detecting a layout operation effected through said input device on said unit images output for display;
unit layout processing of modifying the layout of said unit images output for display on the screen, corresponding to the detected layout operation;
result calculation processing of calculating work load of the structural modification of said unit system, corresponding to the modification of said layout; and
result output processing of outputting said calculated work load to be displayed on said screen.

25. A computer-readable data storage medium for a data processing device that provides, through the Internet, a user terminal device with a web site used for assisting structural modification of a unit system that includes a plurality of unit components vertically engaged and laterally arranged, said computer-readable data storage medium storing a computer program, executed by a processor, that allows said data processing device to execute:
unit storage processing of storing unit data including unit images modeled after front geometries of each of said plurality of types of unit components on a predetermined scale of reduction;
layout storage processing of storing, on the worker basis, a layout data of each of said plurality of unit components composing said unit system;
login acceptance processing of accepting login by said worker through said user terminal device on which said web site is browsed;
image display processing of outputting said plurality of unit images to be displayed on said screen of said web site, according to a layout corresponded to said layout data of said logged-in worker;
operation detection processing of detecting a layout operation effected through said input device on said unit images output for display;
unit layout processing of modifying the layout of said unit images output for display on said screen, corresponding to the detected layout operation;
result calculation processing of calculating work load of the structural modification of said unit system, corresponding to said modification of layout; and
result output processing of outputting said calculated work load to be displayed on said screen.
